(19) United States
(12) Patent Application Publication
(10) Pub. No.: US 2025/0222631 A1
(43) Pub. Date: Jul. 10, 2025

(54) CONTINUOUS PROCESS FOR MAKING FLEXIBLE, POROUS, DISSOLVABLE SOLID SHEET ARTICLES

(71) Applicant: The Procter & Gamble Company, Cincinnati, OH (US)

(72) Inventors: Carl David MAC NAMARA, Beijing (CN); Hong Sing TAN, Beijing (CN); John Philip HECHT, Cincinnati, OH (US); Jason Allen STAMPER, Covington, KY (US)

(21) Appl. No.: 19/015,771

(22) Filed: Jan. 10, 2025

(30) Foreign Application Priority Data
Jan. 10, 2024 (WO) PCT/CN2024/071577

(51) Int. Cl. B29C 41/46; B29C 41/28; B29K 29/00; B29K 105/00

(52) U.S. Cl. CPC B29C 41/46; B29C 41/28; B29K 2029/04; B29K 2105/0005; B29K 2105/0029; B29K 2105/0094; B29K 2995/0062; B29K 2995/0063; B29K 2995/0088

(57) ABSTRACT

A continuous process for preparing a sheet article includes preparing a wet pre-mixture comprising a water-soluble polymer and a surfactant and having a viscosity of from 1,000 cps to 25,000 cps measured at 40° C. and 1 s⁻¹; aerating said wet pre-mixture to form an aerated wet pre-mixture having a density of from 0.05 to 0.5 g/ml; forming said aerated wet pre-mixture into a sheet having a top side and a bottom side; and drying said formed sheet of aerated wet pre-mixture on a conveying belt with the bottom side of said formed sheet contacting said conveying belt.

### TECHNICAL FIELD

The present disclosure relates to a continuous process for making a flexible, porous, dissolvable solid sheet article.

### BACKGROUND

Dissolvable porous solid sheet products have been disclosed, comprising a water-soluble polymeric structurant and a surfactant or other ingredient. However, existing processes for making these dissolvable porous solid structures have less optimal cost, rate of manufacture, and product variability parameters. Particularly, a drum-drying process has been used for making a flexible, porous, dissolvable solid sheet. Although it can provide such solid sheet with desirable properties, the rate of manufacture is quite limited, e.g. 5 to 10 kg of product per hour per drum. On the other hand, a belt-based continuous process has been developed for making a flexible, porous, dissolvable solid sheet to achieve a high rate of manufacture. However, the distribution of pore size in the flexible, porous, dissolvable solid sheet obtained in the current belt-based continuous process is not as uniform as that in the drum-drying process. Additionally, the current drum drying process can make a relatively thin sheet (e.g., around 1 mm), but have challenges to make a thick, solid sheet. In summary, it is desirable to have a thick, solid sheet having a uniform, porous structure, but it is difficult to make such thick, solid sheet via drum drying or existing belt drying process.

Further, it is known that multilayered sheet can contain juice or paste between adjacent layers to provide an additional benefit. In the case of multilayered sheet containing juice or paste, the pore size of the porous solid structure need to be within a preferred range to balance the dissolution and the leakage of juice/paste. Particularly, if the pore size is too large, the juice/paste may be leaked from the multilayered sheet during the storage, while if the pore size is too small, the dissolution performance may not be desirable.

Thus, a need still exists for a process that results in a desired flexible, porous, dissolvable solid sheet article which can be manufactured within the desired cost and rate parameters. Furthermore, a need exists for a process that results in a flexible, porous, dissolvable solid sheet article with a faster drying time, as well as a desirable uniform consistency and preferred pore size in the open celled foam of the flexible, porous, dissolvable solid sheet article.

### SUMMARY

The present invention relates to a continuous process for making a flexible, porous, dissolvable solid sheet article. Particularly, the present invention relates to a continuous process for preparing a sheet article, comprising the steps of:
a) preparing a wet pre-mixture comprising a water-soluble polymer and a surfactant and having a viscosity of from 1,000 cps to 25,000 cps measured at 40° C. and 1 s⁻¹;
b) aerating said wet pre-mixture to form an aerated wet pre-mixture having a density of from 0.05 to 0.5 g/ml;
c) forming said aerated wet pre-mixture into a sheet having a top side and a bottom side; and
d) drying said formed sheet of aerated wet pre-mixture on a conveying belt with the bottom side of said formed sheet contacting said conveying belt,
   wherein the conveying belt is configured to sequentially pass through multiple heating zones with heating temperatures ranging from 70° C. to 200° C.; wherein said multiple heating zones comprises a first heating zone and a second heating zone which is located downstream of said first heating zone;
   wherein said first heating zone is configured to simultaneously heat the top and bottom sides of said formed sheet at a first top heating temperature (Tₜ₁) and a first bottom heating temperature (T_{b1}) for a first heating duration of from 0.01 minutes to 20 minutes; wherein said second heating zone is configured to simultaneously heat the top and bottom sides of said formed sheet at a second top heating temperature (Tₜ₂) and a second bottom heating temperature (T_{b2}) for a second heating duration of from 0.01 minutes to 20 minutes; and
   wherein T_{b1}>Tₜ₁; T_{b1}>T_{b2}; and Tₜ₁<Tₜ₂.

In some embodiments, the first top heating temperature (Tₜ₁) ranges from 70° C. to 160° C.; the first bottom heating temperature (T_{b1}) ranges from 80° C. to 190° C.; the second top heating temperature (Tₜ₂) ranges from 100° C. to 200° C.; and the second bottom heating temperature (T_{b2}) ranges from 70° C. to 170° C.

In some embodiments, Tₜ₁ ranges from 80° C. to 150° C., preferably from 80° C. to 140° C., more preferably from 90° C. to 120° C., for example 80° C., 90° C., 100° C., 110° C., 120° C., 130° C., 140° C., 150° C. or any ranges therebetween; wherein T_{b1} ranges from 90° C. to 170° C., preferably from 100° C. to 160° C., more preferably from 110° C. to 140° C., for example 90° C., 100° C., 110° C., 120° C., 130° C., 140° C., 150° C., 160° C. or any ranges therebetween; wherein Tₜ₂ ranges from 110° C. to 190° C., preferably from 120° C. to 180° C., more preferably from 130° C. to 160° C., for example 110° C., 120° C., 130° C., 140° C., 150° C., 160° C., 170° C., 180° C., or any ranges therebetween; and wherein T_{b2} ranges from 70° C. to 150° C., preferably from 70° C. to 120° C., more preferably from 70° C. to 110° C., for example 70° C., 80° C., 90° C., 100° C., 110° C., 120° C., 130° C., 140° C., 150° C. or any ranges therebetween. Preferably, T_{b2}≤Tₜ₂.

In some embodiments, said multiple heating zones further comprises a third heating zone which is located downstream of said second heating zone and wherein said conveying belt is configured to pass through said third heating zone; wherein said third heating zone is configured to simultaneously heat the top and bottom sides of said formed sheet at a third top heating temperature (Tₜ₃) and a third bottom heating temperature (T_{b3}) for a third heating duration of from 0.01 minutes to 20 minutes; and wherein T_{b2}>T_{b3}; Tₜ₃>Tₜ₂; and T_{b3}<Tₜ₃.

In some embodiments, Tₜ₃ ranges from 120° C. to 200° C., preferably from 130° C. to 190° C.; and wherein T_{b3} ranges from 70° C. to 150° C., preferably from 70° C. to 120° C.

In some embodiments, the multiple heating zones comprises 4, 5, 6, 7, 8, 9, 10, 15, 20, 25, 30 or more heating zones in total in which the n^{th} heating zone is configured to simultaneously heat the top and bottom sides of said formed sheet at a n^{th} top heating temperature (Tₜₙ) and a n^{th} bottom heating temperature (T_{bn}), and wherein T_{bn}≥T_{b(n+1)}; and Tₜₙ≤Tₜ₍ₙ₊₁₎. Preferably, the multiple heating zones comprises 0.1 to 5 (for example 0.2, 0.3, 0.5, 1, 1.5, 2, 2.5, 3, 3.5, 4, 4.5, 5 or any ranges therebetween) heating zones per meter of the conveying belt.

In some embodiments, said first heating duration is from 0.05 minutes to 10 minutes, preferably from 0.1 minutes to 8 minutes; and/or said second heating duration is from 0.05 minutes to 10 minutes, preferably from 0.1 minutes to 8 minutes; and/or said third heating duration from 0.05 minutes to 10 minutes, preferably from 0.1 minutes to 8 minutes; and/or the total heating duration in said multiple heating zones is from 0.05 minutes to 30 minutes, preferably from 0.1 minutes to 20 minutes, more preferably from 0.15 minutes to 15 minutes.

In some embodiments, said formed sheet of aerated wet pre-mixture is characterized by a thickness ranging from 0.5 mm to 20 mm, preferably from 0.8 mm to 15 mm, more preferably from 1 mm to 10 mm, still more preferably from 1.2 mm to 8 mm, most preferably from 1.4 mm to 6 mm, e.g. 1.5 mm, 2 mm, 2.5 mm, 3 mm, 3.5 mm, 4 mm, 5 mm or any ranges therebetween. In a preferred embodiment, the formed sheet is characterized by a thickness ranging from 1.5 mm to 20 mm, preferably from 1.5 mm to 15 mm, more preferably from 1.5 mm to 10 mm, still more preferably from 1.5 mm to 8 mm, most preferably from 1.5 mm to 6 mm.

In some embodiments, said wet pre-mixture comprises from 3% to 70%, preferably from 4% to 50%, more preferably from 5% to 40%, of said water-soluble polymer by total weight of said wet pre-mixture; and/or said wet pre-mixture comprises from 1% to 40%, preferably from 2% to 35%, more preferably from 5% to 30%, of said surfactant by total weight of said wet pre-mixture; and/or the density of the aerated wet pre-mixture is from 0.08 to 0.4 g/ml, preferably from 0.1 to 0.35 g/ml; and/or the wet pre-mixture is characterized by a solid content ranging from 15% to 70%, preferably from 20% to 50%, more preferably from 25% to 45% by weight of said wet pre-mixture; and/or the wet pre-mixture is characterized by a viscosity ranging from 3,000 cps to 24,000 cps, preferably from 5,000 cps to 23,000 cps, more preferably from 10,000 cps to 20,000 cps as measured at 40° C. and 1 s⁻¹.

In some embodiments, said multiple heating zones are configured to heat the top sides of said formed sheet through convective heating, and to heat the bottom sides of said formed sheet through conductive heating.

In another aspect, the present invention relates to a system of belt drying for preparing a sheet article, wherein the system comprises:
a conveying belt which is configured to convey a wet pre-mixture and form the same into a sheet having a top side and a bottom side,
multiple heating components which are configured to dry said wet pre-mixture by heating so as to form said sheet, and
a heating source which is configured to provide heat for said multiple heating components,
wherein the conveying belt is configured to sequentially pass through said multiple heating components with heating temperatures ranging from 70° C. to 200° C.;
wherein comprising a first heating component and a second heating component which is located downstream of said first heating component;
wherein said first heating component is configured to simultaneously heat the top and bottom sides of said formed sheet at a first top heating temperature (Tₜ₁) and a first bottom heating temperature (T_{b1}) for a first heating duration of from 0.01 minutes to 20 minutes; wherein said second heating component is configured to simultaneously heat the top and bottom sides of said formed sheet at a second top heating temperature (Tₜ₂) and a second bottom heating temperature (T_{b2}) for a second heating duration of from 0.01 minutes to 20 minutes; and
wherein T_{b1}>Tₜ₁; T_{b1}>T_{b2}; and Tₜ₁<Tₜ₂.

In a further aspect, the present invention relates to a flexible, porous, dissolvable solid sheet article comprising a water-soluble polymer and a surfactant, wherein said solid sheet article is characterized by: (i) a thickness ranging from 1.5 mm to 20 mm; and (ii) a Percent Open Cell Content of from 80% to 99.9%; (iii) an Overall Average Pore Size of from 100 μm to 1000 μm; and (iv) a Standard Deviation of Overall Average Pore Diameter of from 10 to 250 μm, wherein said solid sheet article has opposing top and bottom surfaces, said top surface having a Surface Average Pore Diameter that is greater than 100 μm; wherein said solid sheet article comprises a top region adjacent to said top surface, a bottom region adjacent to said bottom surface, and a middle region therebetween; wherein said top, middle, and bottom regions have the same thickness, and each of said top, middle and bottom regions is characterized by an Average Pore Size; and wherein the ratio of Average Pore Size in said bottom region over that in said top region is from 0.6 to 1.5. Preferably, the solid sheet article according to the present disclosure may be prepared by the process according to the present disclosure.

In some embodiments, the solid sheet article is characterized by a thickness of from 1.5 mm to 20 mm, preferably from 1.5 mm to 15 mm, more preferably from 1.5 mm to 10 mm, still more preferably from 1.5 mm to 8 mm, most preferably from 1.5 mm to 6 mm, e.g., 1.5 mm, 1.6 mm, 1.7 mm, 1.8 mm, 1.9 mm, 2.0 mm, 2.5 mm, 3.0 mm, 3.5 mm, 4.0 mm, 4.5 mm, 5.0 mm, or any ranges therebetween.

In some embodiments, the solid sheet article is characterized by a Percent Open Cell Content of from 85% to 99.9%, preferably from 90% to 99.9%.

In some embodiments, the solid sheet article is characterized by the Overall Average Pore Size is from 20 to 600 μm, preferably from 50 to 500 μm, more preferably from 100 to 400 μm, e.g. 100 μm, 120 μm, 150 μm, 180 μm, 200 μm, 250 μm, 300 μm, 350 μm, 400 μm or any ranges therebetween.

In some embodiments, the solid sheet article is characterized by the Standard Deviation of Overall Average Pore Diameter is from 20 to 250 μm, preferably from 30 to 250 μm, more preferably from 50 to 200 μm, e.g. 50 μm, 60 μm, 70 μm, 80 μm, 90 μm, 100 μm, 120 μm, 150 μm, 180 μm or any ranges therebetween.

It is advantageous that the continuous process according to the present disclosure can produce more than 200 kg of product per hour which is 20-fold to 40-fold compared to the drum-drying process.

It is further advantageous that the continuous process according to the present disclosure can produce a thick, uniform, solid sheet article. Preferably, the solid sheet article may be characterized by: (i) a thickness ranging from 1.5 mm to 20 mm; and (ii) a Percent Open Cell Content of from 80% to 99.9%; (iii) an Overall Average Pore Size of from 100 μm to 1000 μm; and (iv) a Standard Deviation of Overall Average Pore Diameter of from 10 to 250 μm.

It has been unexpectedly found that a solid sheet article produced according to the continuous process disclosed herein results in a uniform and consistent structure in the open cell foam of the Article. Further, the pore size of the open cell foam of the solid sheet article can be within a preferred range to ensure a better balance between dissolution and leakage of a juice/paste loaded within multiple-layer solid sheet article.

### BRIEF DESCRIPTION OF THE DRAWINGS

FIG. 1 is an exemplary embodiment of the equipment used for practicing a continuous process according to the present disclosure.

FIG. 2 shows multiple heating components in an exemplary system of belt drying according to the present disclosure.

FIG. 3 shows the distribution of pore size across the whole thickness of solid sheet articles produced in various processes including a drum-drying process, a common belt-drying process and a step-wise belt-drying process.

### DETAILED DESCRIPTION OF THE INVENTION

In all embodiments of the present invention, all percentages are by weight of the total composition, unless specifically stated otherwise. All ratios are weight ratios, unless specifically stated otherwise. All ranges are inclusive and combinable. The number of significant digits conveys neither a limitation on the indicated amounts nor on the accuracy of the measurements. All numerical amounts are understood to be modified by the word “about” unless otherwise specifically indicated. Unless otherwise indicated, all measurements are understood to be made at 25° C. and at ambient conditions, where “ambient conditions” means conditions under about one atmosphere of pressure and at about 50% relative humidity. All such weights as they pertain to listed ingredients are based on the active level and do not include carriers or by-products that may be included in commercially available materials, unless otherwise specified.

### Definitions

The flexible porous dissolvable solid structure article may be referred to herein as “the Article” or “the Dissolvable Article”. All references are intended to mean the flexible dissolvable porous solid structure article.

The term “flexible” as used herein refers to the ability of an article to withstand stress without breakage or significant fracture when it is bent at 900 along a center line perpendicular to its longitudinal direction. Preferably, such article can undergo significant elastic deformation and is characterized by a Young's Modulus of no more than 5 GPa, preferably no more than 1 GPa, more preferably no more than 0.5 GPa, most preferably no more than 0.2 GPa.

The term “dissolvable” as used herein refers to the ability of an article to completely or substantially dissolve in a sufficient amount of deionized water at 20° C. and under the atmospheric pressure within eight (8) hours without any stirring, leaving less than 5 wt % undissolved residues.

The term “solid” as used herein refers to the ability of an article to substantially retain its shape (i.e., without any visible change in its shape) at 20° C. and under the atmospheric pressure, when it is not confined and when no external force is applied thereto.

The term “sheet” as used herein refers to a non-fibrous structure having a three-dimensional shape, i.e., with a thickness, a length, and a width, while the length-to-thickness aspect ratio and the width-to-thickness aspect ratio are both at least about 5:1, and the length-to-width ratio is at least about 1:1. Preferably, the length-to-thickness aspect ratio and the width-to-thickness aspect ratio are both at least about 10:1, more preferably at least about 15:1, most preferably at least about 20:1; and the length-to-width aspect ratio is preferably at least about 1.2:1, more preferably at least about 1.5:1, most preferably at least about 1.618:1.

As used herein, the term “continuous” process refers to a manufacturing method where the production of a product is ongoing without a defined start or endpoint. The term “batch” process refers to a manufacturing method where a specific quantity of goods are made in a single production run. It has a defined start and endpoint, meaning the process is completed once the batch has been produced.

As used herein, the term “bottom surface” refers to a surface of the flexible, porous, dissolvable solid sheet article of the present invention that is immediately contacting a supporting surface upon which the sheet of aerated wet pre-mixture is placed during the drying step, while the term “top surface” refers to a surface of the sheet article that is opposite to the bottom surface. Further, such solid sheet article can be divided into three (3) regions along its thickness, including a top region that is adjacent to its top surface, a bottom region that is adjacent to its bottom surface, and a middle region that is located between the top and bottom regions. The top, middle, and bottom regions are of equal thickness, i.e., each having a thickness that is about ⅓ of the total thickness of the sheet article.

The term “open celled foam” or “open cell pore structure” as used herein refers to a solid, interconnected, polymer-containing matrix that defines a network of spaces or cells that contain a gas, typically a gas (such as air), without collapse of the foam structure during the drying process, thereby maintaining the physical strength and cohesiveness of the solid. The interconnectivity of the structure may be described by a Percent Open Cell Content, which is measured by Test 3 disclosed hereinafter.

The term “water-soluble” as used herein refers to the ability of a sample material to completely dissolve in or disperse into water leaving no visible solids or forming no visibly separate phase, when at least about 25 grams, preferably at least about 50 grams, more preferably at least about 100 grams, most preferably at least about 200 grams, of such material is placed in one liter (1 L) of deionized water at 20° C. and under the atmospheric pressure with sufficient stirring.

The term “aerate”, “aerating” or “aeration” as used herein refers to a process of introducing a gas into a liquid or pasty composition by mechanical and/or chemical means.

The term “heating direction” as used herein refers to the direction along which a heat source applies thermal energy to an article, which results in a temperature gradient in such article that decreases from one side of such article to the other side. For example, if a heat source located at one side of the article applies thermal energy to the article to generate a temperature gradient that decreases from the one side to an opposing side, the heating direction is then deemed as extending from the one side to the opposing side. If both sides of such article, or different sections of such article, are heated simultaneously with no observable temperature gradient across such article, then the heating is carried out in a non-directional manner, and there is no heating direction.

The term “substantially opposite to” or “substantially offset from” as used herein refers to two directions or two lines having an offset angle of 900 or more therebetween.

The term “substantially aligned” or “substantial alignment” as used herein refers to two directions or two lines having an offset angle of less than 90° therebetween.

The term “age” or “aging” as used herein refers to a process of maintaining an aerated wet mixture or pre-mixture for a while without further introducing a significant amount of gas. Preferably, the aging may be conducted under the conditions of being essentially free of mechanical energy input and/or being essentially free of heat input. More preferably, the aging may be conducted under the ambient temperature without any stirring.

The term “essentially free of” or “essentially free from” means that the indicated material is at the very minimal not deliberately added to the composition or product, or preferably not present at an analytically detectible level in such composition or product. It may include compositions or products in which the indicated material is present only as an impurity of one or more of the materials deliberately added to such compositions or products.

The test methods disclosed in the Test Methods Section of the present application should be used to determine the respective values of the parameters of Applicants' inventions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Method of Manufacture

The Article can be prepared by the continuous process comprising: a) preparing a wet pre-mixture comprising a water-soluble polymer and a surfactant and having a viscosity of from 1,000 cps to 25,000 cps measured at 40° C. and 1 s⁻¹; b) aerating the wet pre-mixture to form an aerated wet pre-mixture having a density of from 0.05 to 0.5 g/ml; c) forming the aerated wet pre-mixture into a sheet having a top side and a bottom side, for example by extruding the aerated wet pre-mixture; and d) drying the formed sheet of aerated wet pre-mixture on a conveying belt with the bottom side of the formed sheet contacting the conveying belt.

### A. Preparation of Pre-Mixture

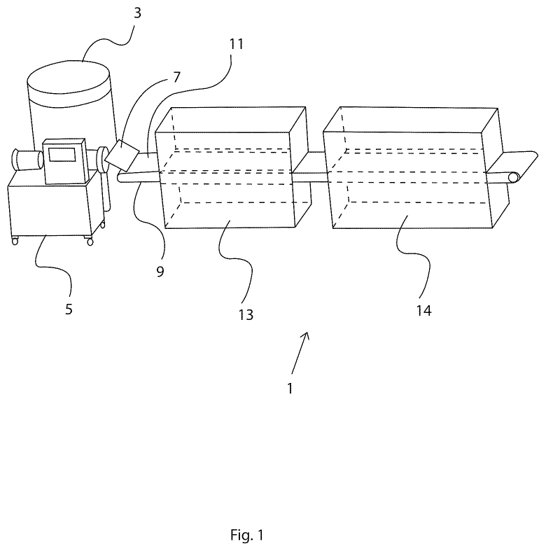

FIG. 1 depicts an exemplary embodiment of the equipment useful for practicing a continuous process for generating an Article. As shown in FIG. 1, in a continuous manufacturing equipment 1, the solids of interest are mixed in a premix tank 3. The pre-mixture is generally prepared by mixing the solids of interest, including surfactant(s), dissolved water soluble polymer, optional plasticizer and other optional ingredients.

In one embodiment, the pre-mixture can be formed using a mechanical mixer. Mechanical mixers useful herein, include, but aren't limited to pitched blade turbines or MAXBLEND mixer (Sumitomo Heavy Industries).

For addition of the ingredients in the pre-mixture, it can be envisioned that the polymer is ultimately dissolved in the presence of water, the surfactant(s), optional actives, optional plasticizer, and any other optional ingredients including step-wise processing via pre-mix portions of any combination of ingredients.

### B. Optional Continued Heating of Pre-Mixture

Optionally, the pre-mixture is pre-heated immediately prior to the aeration process at above ambient temperature but below any temperatures that would cause degradation of the component. In one embodiment, the pre-mixture is kept at above about 40° C. and below about 99° C., in another embodiment above about 50° C. and below about 95° C., in another embodiment from about 60° C. and below about 90° C. In one embodiment, when the viscosity at ambient temperature of the pre-mix is from about 1000 cps to about 20,000 cps, the optional continuous heating is utilized before the aeration step. In an additional embodiment, additional heat is applied during the aeration process to try and maintain an elevated temperature during the aeration. This can be accomplished via conductive heating from one or more surfaces, injection of steam or other processing means.

### C. Aeration of Pre-Mixture

The aeration of the pre-mixture may be accomplished by introducing a gas into the pre-mixture in one embodiment by mechanical mixing energy but also may be achieved via chemical means to form an aerated mixture. As shown in FIG. 1, the aeration of the pre-mixture is achieved by an aeration unit 5. The aeration may be accomplished by any suitable mechanical processing means, including but not limited to: (i) batch tank aeration via mechanical mixing including planetary mixers or other suitable mixing vessels, or (ii) semi-continuous or continuous aerators utilized in the food industry (pressurized and non-pressurized), or (iii) spray-drying the processing mixture in order to form aerated beads or particles that can be compressed such as in a mould with heat in order to form the porous solid.

In another embodiment, aeration with chemical foaming agents by in-situ gas formation (via chemical reaction of one or more ingredients, including formation of carbon dioxide (CO₂ (g)) by an effervescent system) can be used.

In a particular embodiment, it has been discovered that the Article can be prepared within continuous pressurized aerators that are conventionally utilized in the foods industry in the production of marshmallows. Suitable continuous pressurized aerators include the Morton whisk (Morton Machine Co., Motherwell, Scotland), the Oakes continuous automatic mixer (E.T. Oakes Corporation, Hauppauge, New York), the Fedco Continuous Mixer (The Peerless Group, Sidney, Ohio), the Mondo (Haas-Mondomix B.V., Netherlands), the Aeros (Aeros Industrial Equipment Co., Ltd., Guangdong Province, China), and the Preswhip (Hosokawa Micron Group, Osaka, Japan). Continuous mixers may work to homogenize or aerate slurry to produce highly uniform and stable foam structures with uniform bubble sizes. The unique design of the high shear rotor/stator mixing head may lead to uniform bubble sizes in the layers of the open celled foam.

### D. Forming the Aerated Wet Pre-Mixture

As seen in FIG. 1, the forming of the aerated wet pre-mixture is accomplished by extruding the aerated mixture through an extrusion nozzle 7 onto a continuous belt 9 or screen comprising any non-interacting or non-stick material such as solid metallic materials, flexible plastic materials including infrared transparent materials, and combinations thereof. Nonlimiting examples of solid metallic materials include stainless steel. Nonlimiting examples of flexible plastic materials including but are not limited to materials such as HDPE, polycarbonate, NEOPRENE®, rubber, LDPE, and fiberglass. Nonlimiting examples of infrared transparent materials include but are not limited to TEFLON®.

After extrusion, the aerated wet pre-mixture forms one or more sheets. In one embodiment, one sheet 11 forms the Article having a thickness of from about 0.5 mm to about 20 mm. In another embodiment, the Article has a thickness of about 1 to 2 mm. In another embodiment, two or more sheets 11 are combined to form an Article having a final thickness from about 2 mm to about 10 mm. The extrusion of thinner sheets that are then combined to form an Article allows for a faster drying time for the individual sheets. The sheets can be combined by any means known in the art, examples of which include but are not limited to, chemical means, mechanical means, and combinations thereof. The combination of the sheets allows for two or more sheets to be stacked on top of one another.

The wet density range of the aerated pre-mixture ranges from about 0.05 g/cm³ to about 0.5 g/cm³, from about 0.10 g/cm³ to about 0.45 g/cm³, from about 0.20 g/cm³ to about 0.40 g/cm³, and from about 0.25 g/cm³ to about 0.35 g/cm³.

### E. Step-Wise Drying the Formed Aerated Wet Pre-Mixture

The drying of the formed aerated wet pre-mixture according to the present application is a step-wise process. Particularly, the conveying belt is configured to sequentially pass through multiple heating zones with heating temperatures ranging from 70° C. to 200° C.; wherein said multiple heating zones comprises a first heating zone and a second heating zone which is located downstream of said first heating zone. More particularly, said first heating zone is configured to simultaneously heat the top and bottom sides of said formed sheet at a first top heating temperature (Tₜ₁) and a first bottom heating temperature (T_{b1}) for a first heating duration of from 0.01 minutes to 20 minutes; wherein said second heating zone is configured to simultaneously heat the top and bottom sides of said formed sheet at a second top heating temperature (Tₜ₂) and a second bottom heating temperature (T_{b2}) for a second heating duration of from 0.01 minutes to 20 minutes; and wherein T_{b1}>Tₜ₁; T_{b1}>T_{b2}; and Tₜ₁<Tₜ₂.

As seen in FIG. 1, the drying of the formed aerated wet pre-mixture may be accomplished by any suitable drying environments 13 and 14 including, but not limited to (i) drying room(s) including rooms with controlled temperature and pressure or atmospheric conditions; (ii) ovens including non-convection or convection ovens with controlled temperature and optionally humidity; (iii) Truck/Tray driers, (iv) multi-stage inline driers; (v) impingement ovens; (vi) rotary ovens/driers; (vii) inline roasters; (viii) rapid high heat transfer ovens and driers; (ix) dual plenum roasters; (x) conveyor driers; (xi) vacuum drying chambers; (xii) air distribution plate; (xiii) venturi dryers and combinations thereof. The drying environments 13 and 14 can provide different heating temperatures.

In one embodiment, the drying environments 13 and 14 are selected from the group consisting of one or more drying rooms, convection ovens, multi-tier ovens, Truck/Tray driers, multi-stage inline driers, impingement ovens/driers, rotary ovens/driers, inline roasters, rapid high heat transfer ovens and driers, dual plenum roasters, conveyor driers, vacuum drying chambers and combinations thereof, such that the drying environment is between 100° C. and 150° C.

Other suitable drying environments include “volumetric heating” techniques using high frequency electromagnetic fields such as microwave drying and infrared drying. With these techniques, the energy is transferred electromagnetically through the aerated wet pre-mixture rather than by conduction or convection.

In some embodiments, the first top heating temperature (Tₜ₁) in the drying environment 13 ranges from 70° C. to 160° C.; the first bottom heating temperature (T_{b1}) in the drying environment 13 ranges from 80° C. to 190° C.; the second top heating temperature (Tₜ₂) in the drying environment 14 ranges from 100° C. to 200° C.; and the second bottom heating temperature (T_{b2}) in the drying environment 14 ranges from 70° C. to 170° C.

In some embodiments, Tₜ₁ ranges from 80° C. to 150° C., preferably from 80° C. to 140° C.; wherein T_{b1} ranges from 90° C. to 170° C., preferably from 100° C. to 160° C.; wherein Tₜ₂ ranges from 110° C. to 190° C., preferably from 120° C. to 180° C.; and wherein T_{b2} ranges from 70° C. to 150° C., preferably from 70° C. to 120° C.; and wherein T_{b2}≤Tₜ₂.

In some embodiments, said multiple heating zones further comprises a third heating zone and wherein said conveying belt is configured to pass through said third heating zone; wherein said third heating zone is configured to simultaneously heat the top and bottom sides of said formed sheet at a third top heating temperature (Tₜ₃) and a third bottom heating temperature (T_{b3}) for a third heating duration of from 0.01 minutes to 20 minutes.

In some embodiments, T_{b2}≥T_{b3}; Tₜ₂≤Tₜ₃; and T_{b3}≤Tₜ₃ when said third heating zone is located downstream of said second heating zone.

In some embodiments, T_{b1}≥T_{b3}≥T_{b2}; Tₜ₁≤Tₜ₃≤Tₜ₂ when said third heating zone is located downstream of said first heating zone and upstream of said second heating zone.

In some embodiments, T_{b3}≥T_{b1}; Tₜ₃≤Tₜ₁; and T_{b3}≥Tₜ₃ when said third heating zone is located upstream of said first heating zone.

In some embodiments, Tₜ₃ ranges from 90° C. to 200° C.; and wherein T_{b3} ranges from 70° C. to 180° C.

In some embodiments, said first heating duration is from 0.1 minutes to 10 minutes, preferably from 0.15 minutes to 8 minutes; and/or said second heating duration is from 0.1 minutes to 10 minutes, preferably from 0.15 minutes to 8 minutes; and/or said third heating duration is from 0.1 minutes to 10 minutes, preferably from 0.15 minutes to 8 minutes; and/or the total heating duration in said multiple heating zones is from 0.3 minutes to 30 minutes, preferably from 0.5 minutes to 20 minutes, more preferably from 0.6 minutes to 15 minutes.

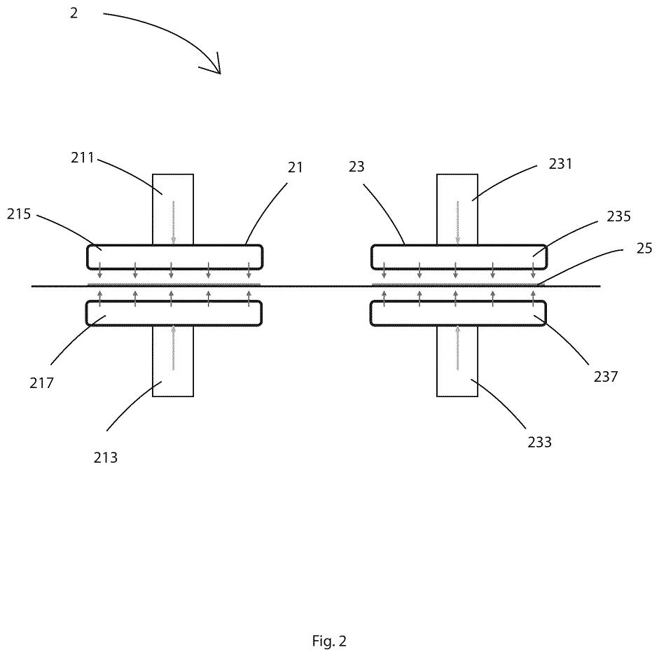

In an exemplary system of step-wise belt drying as shown in FIG. 2, the system 2 comprises a first heating zone 21 and a second heating zone 23. In the first heating zone 21, hot air is respectively introduced from a first top inlet 211 and a first bottom inlet 213 to a first top air distribution plate 215 and a first bottom air distribution plate 217 and then applied onto the top surface and the bottom surface of the belt as a hot air jet (as shown by the arrows). In the first heating zone 23, hot air is respectively introduced from a first top inlet 231 and a first bottom inlet 233 to a first top air distribution plate 235 and a first bottom air distribution plate 237 and then applied onto the top surface and the bottom surface of the belt as a hot air jet (as shown by the arrows). Particularly, the air distribution plates 215, 217, 235, and 237 respectively comprise a plurality of holes through which the hot air jet can be ejected onto the sheets formed on the belt or the belt itself for conductive and convective heating of the foam. Then, one dried solid sheet 25 is formed on the belt after drying.

The resulting Article also has an open celled foam with a percent open cells of from about 80% to about 100%. It has been unexpectedly found that the Article produced by the continuous process has uniformity in the upper, middle, and lower regions of the open celled foam.

The solid sheet article may comprise a top region adjacent to the top surface, a bottom region adjacent to the bottom surface, and a middle region therebetween; wherein the top, middle, and bottom regions have the same thickness, and each of the top, middle and bottom regions is characterized by an Average Pore Size (i.e., Top Average Pore Diameter, Middle Average Pore Diameter, and Bottom Average Pore Diameter). Particularly, the ratio of Average Pore Size in the bottom region over that in the top region may be from about 0.6 to about 1.5, preferably from about 0.7 to about 1.4, more preferably from about 0.8 to about 1.3, most preferably from about 0.9 to about 1.2; and/or the ratio of Average Pore Size in the bottom region over that in the middle region may be from about 0.6 to about 1.5, preferably from about 0.7 to about 1.4, more preferably from about 0.8 to about 1.3, most preferably from about 0.9 to about 1.2; and/or the ratio of Average Pore Size in the middle region over that in the top region may be from about 0.6 to about 1.5, preferably from about 0.7 to about 1.4, more preferably from about 0.8 to about 1.3, most preferably from about 0.9 to about 1.2.

### F. Further Optional Steps

Further optional steps not recited above may be added at any point during or after the recited process. Optional ingredients may be imparted during any of the above described four processing steps or even after the drying process.

Additional steps that can be used in the present process include cutting the resulting Article into smaller sizes, puncturing the Article with needles or slitting the Article. The size of the Article will depend upon the desired dosage amount of actives, or in this case surfactant. The frequency of perforation or slitting is confined to maintain the structural integrity of the Article such that it can still be handled.

The Article may be further manipulated into a shape or form other than a flat plane or sheet. Other three-dimensional shapes may include spherical bead or ball, flowers, flower petals, berry shapes and various known pasta shapes. As such the process may further include a step whereby the Article is manipulated into a three-dimensional shape.

The Article may be packaged for consumption individually or in a plurality of Articles. The Article may be included in a kit wherein various types of products are supplied, including Articles with different compositions, Article(s) with other products making up a regime of series of products for a desired benefit, or Article(s) with other products unrelated such as a toiletry travel kit for travel on airplanes.

Suitable packaging material may be selected such that the Article is protected from inadvertent exposure to liquids. The packaging material may be air and/or vapor permeable, dependent upon the environment in which the Article is to be sold.

The process may further include a step of packaging the Article individually for sale as a product. The process may further include a step of packaging a plurality of Article for sale as a product. The process may further include a step of including a packaged Article in a kit for sale as a product. The packaging step is undertaken after the formation of the Article, in one embodiment after the Article is cut into a suitable size. The Article may be packaged on the same line as the production of Article or the Article may be collected, shipped or stored, and then packaged at a later time.

### Composition of Article

### 1. Water-Soluble Polymer

As mentioned hereinabove, the flexible, porous, dissolvable solid sheet article of the present invention may be formed by a wet pre-mixture that comprises a water-soluble polymer and a surfactant. Such a water-soluble polymer may function in the resulting solid sheet article as a film-former, a structurant as well as a carrier for other active ingredients (e.g., surfactants, emulsifiers, builders, chelants, perfumes, colorants, and the like).

Preferably, the wet pre-mixture may comprise from about 3% to about 70% by weight of the pre-mixture of water soluble polymer, in one embodiment from about 4% to about 50% by weight of the pre-mixture of water soluble polymer, in one embodiment from about 5% to about 40% by weight of the pre-mixture of water soluble polymer.

After drying, it is preferred that the water-soluble polymer is present in the flexible, porous, dissolvable solid sheet article of the present invention in an amount ranging from about 5% to about 60%, preferably from about 8% to about 50%, more preferably from about 10% to about 40%, e.g., 50%, 40%, 30%, 20%, 10%, or any ranges therebetween, by total weight of the solid sheet article. In a particularly preferred embodiment of the present invention, the total amount of water-soluble polymer(s) present in the flexible, porous, dissolvable solid sheet article of the present invention is no more than 25% by total weight of such article.

Water-soluble polymers suitable for the practice of the present invention may be selected those with weight average molecular weights ranging from about 5,000 to about 400,000 Daltons, more preferably from about 10,000 to about 300,000 Daltons, still more preferably from about 15,000 to about 200,000 Daltons, most preferably from about 20,000 to about 150,000 Daltons. The weight average molecular weight is computed by summing the average molecular weights of each polymer raw material multiplied by their respective relative weight percentages by weight of the total weight of polymers present within the porous solid. The weight average molecular weight of the water-soluble polymer used herein may impact the viscosity of the wet pre-mixture, which may in turn influence the bubble number and size during the aeration step as well as the pore expansion/opening results during the drying step. Further, the weight average molecular weight of the water-soluble polymer may affect the overall film-forming properties of the wet pre-mixture and its compatibility/incompatibility with certain surfactants.

The water-soluble polymers of the present invention may include, but are not limited to, synthetic polymers including polyvinyl alcohols, polyvinylpyrrolidones, polyalkylene oxides, polyacrylates, caprolactams, polymethacrylates, polymethylmethacrylates, polyacrylamides, polymethylacrylamides, polydimethylacrylamides, polyethylene glycol monomethacrylates, copolymers of acrylic acid and methyl acrylate, polyurethanes, polycarboxylic acids, polyvinyl acetates, polyesters, polyamides, polyamines, polyethyleneimines, maleic/(acrylate or methacrylate) copolymers, copolymers of methylvinyl ether and of maleic anhydride, copolymers of vinyl acetate and crotonic acid, copolymers of vinylpyrrolidone and of vinyl acetate, copolymers of vinylpyrrolidone and of caprolactam, vinyl pyrollidone/vinyl acetate copolymers, copolymers of anionic, cationic and amphoteric monomers, and combinations thereof.

The water-soluble polymers of the present invention may also be selected from naturally sourced polymers including those of plant origin examples of which include karaya gum, tragacanth gum, gum Arabic, acemannan, konjac mannan, acacia gum, gum ghatti, whey protein isolate, and soy protein isolate; seed extracts including guar gum, locust bean gum, quince seed, and psyllium seed; seaweed extracts such as Carrageenan, alginates, and agar; fruit extracts (pectins); those of microbial origin including xanthan gum, gellan gum, pullulan, hyaluronic acid, chondroitin sulfate, and dextran; and those of animal origin including casein, gelatin, keratin, keratin hydrolysates, sulfonic keratins, albumin, collagen, glutelin, glucagons, gluten, zein, and shellac.

Modified natural polymers can also be used as water-soluble polymers in the present invention. Suitable modified natural polymers include, but are not limited to, cellulose derivatives such as hydroxypropylmethylcellulose, hydroxymethylcellulose, hydroxyethylcellulose, methylcellulose, hydroxypropylcellulose, ethylcellulose, carboxymethylcellulose, cellulose acetate phthalate, nitrocellulose and other cellulose ethers/esters; and guar derivatives such as hydroxypropyl guar.

The water-soluble polymer of the present invention may include starch. As used herein, the term “starch” include both naturally occurring or modified starches. Typical natural sources for starches can include cereals, tubers, roots, legumes and fruits. More specific natural sources can include corn, pea, potato, banana, barley, wheat, rice, sago, amaranth, tapioca, arrowroot, canna, sorghum, and waxy or high amylase varieties thereof. The natural starches can be modified by any modification method known in the art to form modified starches, including physically modified starches, such as sheared starches or thermally-inhibited starches; chemically modified starches, such as those which have been cross-linked, acetylated, and organically esterified, hydroxyethylated, and hydroxypropylated, phosphorylated, and inorganically esterified, cationic, anionic, nonionic, amphoteric and zwitterionic, and succinate and substituted succinate derivatives thereof; conversion products derived from any of the starches, including fluidity or thin-boiling starches prepared by oxidation, enzyme conversion, acid hydrolysis, heat or acid dextrinization, thermal and or sheared products may also be useful herein; and pregelatinized starches which are known in the art.

Preferred water-soluble polymers of the present invention include polyvinyl alcohols, polyvinylpyrrolidones, polyalkylene oxides, starch and starch derivatives, pullulan, gelatin, hydroxypropylmethylcelluloses, methycelluloses, and carboxymethycelluloses. More preferred water-soluble polymers of the present invention include polyvinyl alcohols, and hydroxypropylmethylcelluloses.

Most preferred water-soluble polymers of the present invention are polyvinyl alcohols characterized by a degree of hydrolysis ranging from about 40% to about 100%, preferably from about 50% to about 95%, more preferably from about 65% to about 92%, most preferably from about 70% to about 90%. Commercially available polyvinyl alcohols include those from Celanese Corporation (Texas, USA) under the CELVOL trade name including, but not limited to, CELVOL 523, CELVOL 530, CELVOL 540, CELVOL 518, CELVOL 513, CELVOL 508, CELVOL 504; those from Kuraray Europe GmbH (Frankfurt, Germany) under the Mowiol® and POVAL™ trade names; and PVA 1788 (also referred to as PVA BP17) commercially available from various suppliers including Lubon Vinylon Co. (Nanjing, China); and combinations thereof. In a particularly preferred embodiment of the present invention, the flexible, porous, dissolvable solid sheet article comprises from about 10% to about 25%, more preferably from about 15% to about 23%, by total weight of such article, of a polyvinyl alcohol having a weight average molecular weight ranging from 80,000 to about 150,000 Daltons and a degree of hydrolysis ranging from about 80% to about 90%.

In addition to polyvinyl alcohols as mentioned hereinabove, a single starch or a combination of starches may be used as a filler material in such an amount as to reduce the overall level of water-soluble polymers required, so long as it helps provide the solid sheet article with the requisite structure and physical/chemical characteristics as described herein. However, too much starch may comprise the solubility and structural integrity of the sheet article. Therefore, in preferred embodiments of the present invention, it is desired that the solid sheet article comprises no more than 20%, preferably from 0% to 10%, more preferably from 0% to 5%, most preferably from 0% to 1%, by weight of said solid sheet article, of starch.

### 2. Surfactants

In addition to the water-soluble polymer described hereinabove, the solid sheet article of the present invention comprises one or more surfactants. The surfactants may function as emulsifying agents during the aeration process to create a sufficient amount of stable bubbles for forming the desired OCF structure of the present invention. Further, the surfactants may function as active ingredients for delivering a desired cleansing benefit.

In a preferred embodiment of the present invention, the solid sheet article comprises one or more surfactants selected from the group consisting of anionic surfactants, nonionic surfactants, cationic surfactants, zwitterionic surfactants, amphoteric surfactants, polymeric surfactants or combinations thereof. Depending on the desired application of such solid sheet article and the desired consumer benefit to be achieved, different surfactants can be selected. One benefit of the present invention is that the OCF structures of the solid sheet article allow for incorporation of a high surfactant content while still providing fast dissolution. Consequently, highly concentrated cleansing compositions can be formulated into the solid sheet articles of the present invention to provide a new and superior cleansing experience to the consumers.

The surfactant as used herein may include both surfactants from the conventional sense (i.e., those providing a consumer-noticeable lathering effect) and emulsifiers (i.e., those that do not provide any lathering performance but are intended primarily as a process aid in making a stable foam structure). Examples of emulsifiers for use as a surfactant component herein include mono- and di-glycerides, fatty alcohols, polyglycerol esters, propylene glycol esters, sorbitan esters and other emulsifiers known or otherwise commonly used to stabilize air interfaces.

The total amount of surfactants present in the solid sheet article of the present invention may range widely from about 5% to about 80%, preferably from about 10% to about 70%, more preferably from about 30% to about 65%, by total weight of said solid sheet article. Correspondingly, the wet pre-mixture may comprise from about 1% to about 40% by weight of the wet pre-mixture of surfactant(s), in one embodiment from about 2% to about 35% by weight of the wet pre-mixture of surfactant(s), in one embodiment from about 5% to about 30% by weight of the wet pre-mixture of surfactant(s).

In a preferred embodiment of the present invention, the solid sheet article of the present invention is a cleansing product containing from about 30% to about 80%, preferably from about 40% to about 70%, more preferably from about 50% to about 65%, of one or more surfactants by total weight of said solid sheet article. In such cases, the wet pre-mixture may comprise from about 10% to about 40% by weight of the wet pre-mixture of surfactant(s), in one embodiment from about 12% to about 35% by weight of the wet pre-mixture of surfactant(s), in one embodiment from about 15% to about 30% by weight of the wet pre-mixture of surfactant(s).

Non-limiting examples of anionic surfactants suitable for use herein include alkyl and alkyl ether sulfates, sulfated monoglycerides, sulfonated olefins, alkyl aryl sulfonates, primary or secondary alkane sulfonates, alkyl sulfosuccinates, acyl taurates, acyl isethionates, alkyl glycerylether sulfonate, sulfonated methyl esters, sulfonated fatty acids, alkyl phosphates, acyl glutamates, acyl sarcosinates, alkyl sulfoacetates, acylated peptides, alkyl ether carboxylates, acyl lactylates, anionic fluorosurfactants, sodium lauroyl glutamate, and combinations thereof.

One category of anionic surfactants particularly suitable for practice of the present invention include C₆-C₂₀ linear alkylbenzene sulphonate (LAS) surfactant. LAS surfactants are well known in the art and can be readily obtained by sulfonating commercially available linear alkylbenzenes. Exemplary C₁₀-C₂₀ linear alkylbenzene sulfonates that can be used in the present invention include alkali metal, alkaline earth metal or ammonium salts of C₁₀-C₂₀ linear alkylbenzene sulfonic acids, and preferably the sodium, potassium, magnesium and/or ammonium salts of C₁₁-C₁₈ or C₁₁-C₁₄ linear alkylbenzene sulfonic acids. More preferred are the sodium or potassium salts of C₁₂ and/or C₁₄ linear alkylbenzene sulfonic acids, and most preferred is the sodium salt of C₁₂ and/or C₁₄ linear alkylbenzene sulfonic acid, i.e., sodium dodecylbenzene sulfonate or sodium tetradecylbenzene sulfonate.

LAS provides superior cleaning benefit and is especially suitable for use in laundry detergent applications. It has been a surprising and unexpected discovery of the present invention that when polyvinyl alcohol having a higher weight average molecular weight (e.g., from about 50,000 to about 400,000 Daltons, preferably from about 60,000 to about 300,000 Daltons, more preferably from about 70,000 to about 200,000 Daltons, most preferably from about 80,000 to about 150,000 Daltons) is used as the film-former and carrier, LAS can be used as a major surfactant, i.e., present in an amount that is more than 50% by weight of the total surfactant content in the solid sheet article, without adversely affecting the film-forming performance and stability of the overall composition. Correspondingly, in a particular embodiment of the present invention, LAS is used as the major surfactant in the solid sheet article. If present, the amount of LAS in the solid sheet article of the present invention may range from about 10% to about 70%, preferably from about 20% to about 65%, more preferably from about 40% to about 60%, by total weight of the solid sheet article.

Another category of anionic surfactants suitable for practice of the present invention include sodium trideceth sulfates (STS) having a weight average degree of alkoxylation ranging from about 0.5 to about 5, preferably from about 0.8 to about 4, more preferably from about 1 to about 3, most preferably from about 1.5 to about 2.5. Trideceth is a 13-carbon branched alkoxylated hydrocarbon comprising, in one embodiment, an average of at least 1 methyl branch per molecule. STS used by the present invention may be include ST(EOxPOy)S, while EOx refers to repeating ethylene oxide units with a repeating number x ranging from 0 to 5, preferably from 1 to 4, more preferably from 1 to 3, and while POy refers to repeating propylene oxide units with a repeating number y ranging from 0 to 5, preferably from 0 to 4, more preferably from 0 to 2. It is understood that a material such as ST2S with a weight average degree of ethoxylation of about 2, for example, may comprise a significant amount of molecules which have no ethoxylate, 1 mole ethoxylate, 3 mole ethoxylate, and so on, while the distribution of ethoxylation can be broad, narrow or truncated, which still results in an overall weight average degree of ethoxylation of about 2. STS is particularly suitable for personal cleansing applications, and it has been a surprising and unexpected discovery of the present invention that when polyvinyl alcohol having a higher weight average molecular weight (e.g., from about 50,000 to about 400,000 Daltons, preferably from about 60,000 to about 300,000 Daltons, more preferably from about 70,000 to about 200,000 Daltons, most preferably from about 80,000 to about 150,000 Daltons) is used as the film-former and carrier, STS can be used as a major surfactant, i.e., present in an amount that is more than 50% by weight of the total surfactant content in the solid sheet article, without adversely affecting the film-forming performance and stability of the overall composition. Correspondingly, in a particular embodiment of the present invention, STS is used as the major surfactant in the solid sheet article. If present, the amount of STS in the solid sheet article of the present invention may range from about 10% to about 70%, preferably from about 20% to about 65%, more preferably from about 40% to about 60%, by total weight of the solid sheet article.

Another category of anionic surfactants suitable for practice of the present invention include alkyl sulfates. These materials have the respective formulae ROSO₃M, wherein R is alkyl or alkenyl of from about 6 to about 20 carbon atoms, x is 1 to 10, and M is a water-soluble cation such as ammonium, sodium, potassium and triethanolamine. Preferably, R has from about 6 to about 18, preferably from about 8 to about 16, more preferably from about 10 to about 14, carbon atoms. Previously, unalkoxylated C₆-C₂₀ linear or branched alkyl sulfates (AS) have been considered the preferred surfactants in dissolvable solid sheet articles, especially as the major surfactant therein, due to its compatibility with low molecular weight polyvinyl alcohols (e.g., those with a weight average molecular weight of no more than 50,000 Daltons) in film-forming performance and storage stability. However, it has been a surprising and unexpected discovery of the present invention that when polyvinyl alcohol having a higher weight average molecular weight (e.g., from about 50,000 to about 400,000 Daltons, preferably from about 60,000 to about 300,000 Daltons, more preferably from about 70,000 to about 200,000 Daltons, most preferably from about 80,000 to about 150,000 Daltons) is used as the film-former and carrier, other surfactants, such as LAS and/or STS, can be used as the major surfactant in the solid sheet article, without adversely affecting the film-forming performance and stability of the overall composition. Therefore, in a particularly preferred embodiment of the present invention, it is desirable to provide a solid sheet article with no more than about 20%, preferably from 0% to about 10%, more preferably from 0% to about 5%, most preferably from 0% to about 1%, by weight of said solid sheet article, of AS.

Another category of anionic surfactants suitable for practice of the present invention include C₆-C₂₀ linear or branched alkylalkoxy sulfates (AAS). Among this category, linear or branched alkylethoxy sulfates (AES) having the respective formulae RO(C₂H₄O)ₓSO₃M are particularly preferred, wherein R is alkyl or alkenyl of from about 6 to about 20 carbon atoms, x is 1 to 10, and M is a water-soluble cation such as ammonium, sodium, potassium and triethanolamine. Preferably, R has from about 6 to about 18, preferably from about 8 to about 16, more preferably from about 10 to about 14, carbon atoms. The AES surfactants are typically made as condensation products of ethylene oxide and monohydric alcohol's having from about 6 to about 20 carbon atoms. Useful alcohols can be derived from fats, e.g., coconut oil or tallow, or can be synthetic. Lauryl alcohol and straight chain alcohol's derived from coconut oil are preferred herein. Such alcohol's are reacted with about 1 to about 10, preferably from about 3 to about 5, and especially about 3, molar proportions of ethylene oxide and the resulting mixture of molecular species having, for example, an average of 3 moles of ethylene oxide per mole of alcohol, is sulfated and neutralized. Highly preferred AES are those comprising a mixture of individual compounds, said mixture having an average alkyl chain length of from about 10 to about 16 carbon atoms and an average degree of ethoxylation of from about 1 to about 4 moles of ethylene oxide. If present, the the amount of AAS in the solid sheet article of the present invention may range from about 2% to about 40%, preferably from about 5% to about 30%, more preferably from about 8% to about 12%, by total weight of the solid sheet article.

Other suitable anionic surfactants include water-soluble salts of the organic, sulfuric acid reaction products of the general formula [R¹—SO₃-M], wherein R¹ is chosen from the group consisting of a straight or branched chain, saturated aliphatic hydrocarbon radical having from about 6 to about 20, preferably about 10 to about 18, carbon atoms; and M is a cation. Preferred are alkali metal and ammonium sulfonated C₁₀₋₁₈ n-paraffins. Other suitable anionic surfactants include olefin sulfonates having about 12 to about 24 carbon atoms. The □-olefins from which the olefin sulfonates are derived are mono-olefins having about 12 to about 24 carbon atoms, preferably about 14 to about 16 carbon atoms. Preferably, they are straight chain olefins.

Another class of anionic surfactants suitable for use in the fabric and home care compositions is the □-alkyloxy alkane sulfonates. These compounds have the following formula:

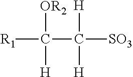

where R₁ is a straight chain alkyl group having from about 6 to about 20 carbon atoms, R₂ is a lower alkyl group having from about 1 (preferred) to about 3 carbon atoms, and M is a water-soluble cation as hereinbefore described.

Additional examples of suitable anionic surfactants are the reaction products of fatty acids esterified with isethionic acid and neutralized with sodium hydroxide where, for example, the fatty acids are derived from coconut oil; sodium or potassium salts of fatty acid amides of methyl tauride in which the fatty acids, for example, are derived from coconut oil. Still other suitable anionic surfactants are the succinamates, examples of which include disodium N-octadecylsulfosuccinamate; diammoniumlauryl sulfosuccinamate; tetrasodium N-(1,2-dicarboxyethyl)-N-octadecylsulfosuccinamate; diamyl ester of sodium sulfosuccinic acid; dihexyl ester of sodium sulfosuccinic acid; and dioctyl esters of sodium sulfosuccinic acid.

Nonionic surfactants that can be included into the solid sheet article of the present invention may be any conventional nonionic surfactants, including but not limited to: alkyl alkoxylated alcohols, alkyl alkoxylated phenols, alkyl polysaccharides (especially alkyl glucosides and alkyl polyglucosides), polyhydroxy fatty acid amides, alkoxylated fatty acid esters, sucrose esters, sorbitan esters and alkoxylated derivatives of sorbitan esters, amine oxides, and the like. Preferred nonionic surfactants are those of the formula R¹(OC₂H₄)ₙOH, wherein R¹ is a C₈-C₁₈ alkyl group or alkyl phenyl group, and n is from about 1 to about 80. Particularly preferred are C₈-C₁₈ alkyl ethoxylated alcohols having a weight average degree of ethoxylation from about 1 to about 20, preferably from about 5 to about 15, more preferably from about 7 to about 10, such as NEODOL® nonionic surfactants commercially available from Shell. Other non-limiting examples of nonionic surfactants useful herein include: C₆-C₁₂ alkyl phenol alkoxylates where the alkoxylate units may be ethyleneoxy units, propyleneoxy units, or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols (BA); C₁₄-C₂₂ mid-chain branched alkyl alkoxylates, BAEₓ, wherein x is from 1 to 30; alkyl polysaccharides, specifically alkyl polyglycosides; Polyhydroxy fatty acid amides; and ether capped poly(oxyalkylated) alcohol surfactants. Suitable nonionic surfactants also include those sold under the tradename Lutensol® from BASF.

In a preferred embodiment, the nonionic surfactant is selected from sorbitan esters and alkoxylated derivatives of sorbitan esters including sorbitan monolaurate (SPAN® 20), sorbitan monopalmitate (SPAN® 40), sorbitan monostearate (SPAN® 60), sorbitan tristearate (SPAN® 65), sorbitan monooleate (SPAN® 80), sorbitan trioleate (SPAN® 85), sorbitan isostearate, polyoxyethylene (20) sorbitan monolaurate (Tween® 20), polyoxyethylene (20) sorbitan monopalmitate (Tween® 40), polyoxyethylene (20) sorbitan monostearate (Tween® 60), polyoxyethylene (20) sorbitan monooleate (Tween® 80), polyoxyethylene (4) sorbitan monolaurate (Tween® 21), polyoxyethylene (4) sorbitan monostearate (Tween® 61), polyoxyethylene (5) sorbitan monooleate (Tween® 81), all available from Uniqema, and combinations thereof.

The most preferred nonionic surfactants for practice of the present invention include C₆-C₂₀ linear or branched alkylalkoxylated alcohols (AA) having a weight average degree of alkoxylation ranging from 5 to 15, more preferably C₁₂-C₁₄ linear ethoxylated alcohols having a weight average degree of alkoxylation ranging from 7 to 9. If present, the amount of AA-type nonionic surfactant(s) in the solid sheet article of the present invention may range from about 2% to about 40%, preferably from about 5% to about 30%, more preferably from about 8% to about 12%, by total weight of the solid sheet article.

Amphoteric surfactants suitable for use in the solid sheet article of the present invention includes those that are broadly described as derivatives of aliphatic secondary and tertiary amines in which the aliphatic radical can be straight or branched chain and wherein one of the aliphatic substituents contains from about 8 to about 18 carbon atoms and one contains an anionic water solubilizing group, e.g., carboxy, sulfonate, sulfate, phosphate, or phosphonate. Examples of compounds falling within this definition are sodium 3-dodecyl-aminopropionate, sodium 3-dodecylaminopropane sulfonate, sodium lauryl sarcosinate, N-alkyltaurines such as the one prepared by reacting dodecylamine with sodium isethionate, and N-higher alkyl aspartic acids.

One category of amphoteric surfactants particularly suitable for incorporation into solid sheet articles with personal care applications (e.g., shampoo, facial or body cleanser, and the like) include alkylamphoacetates, such as lauroamphoacetate and cocoamphoacetate. Alkylamphoacetates can be comprised of monoacetates and diacetates. In some types of alkylamphoacetates, diacetates are impurities or unintended reaction products. If present, the amount of alkylamphoacetate(s) in the solid sheet article of the present invention may range from about 2% to about 40%, preferably from about 5% to about 30%, more preferably from about 10% to about 20%, by total weight of the solid sheet article.

Zwitterionic surfactants suitable include those that are broadly described as derivatives of aliphatic quaternary ammonium, phosphonium, and sulfonium compounds, in which the aliphatic radicals can be straight or branched chain, and wherein one of the aliphatic substituents contains from about 8 to about 18 carbon atoms and one contains an anionic group, e.g., carboxy, sulfonate, sulfate, phosphate, or phosphonate. Such suitable zwitterionic surfactants can be represented by the formula:

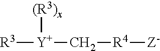

wherein R² contains an alkyl, alkenyl, or hydroxy alkyl radical of from about 8 to about 18 carbon atoms, from 0 to about 10 ethylene oxide moieties and from 0 to about 1 glyceryl moiety; Y is selected from the group consisting of nitrogen, phosphorus, and sulfur atoms; R³ is an alkyl or monohydroxyalkyl group containing about 1 to about 3 carbon atoms; X is 1 when Y is a sulfur atom, and 2 when Y is a nitrogen or phosphorus atom; R⁴ is an alkylene or hydroxyalkylene of from about 1 to about 4 carbon atoms and Z is a radical selected from the group consisting of carboxylate, sulfonate, sulfate, phosphonate, and phosphate groups.

Other zwitterionic surfactants suitable for use herein include betaines, including high alkyl betaines such as coco dimethyl carboxymethyl betaine, cocoamidopropyl betaine, cocobetaine, lauryl amidopropyl betaine, oleyl betaine, lauryl dimethyl carboxymethyl betaine, lauryl dimethyl alphacarboxyethyl betaine, cetyl dimethyl carboxymethyl betaine, lauryl bis-(2-hydroxyethyl) carboxymethyl betaine, stearyl bis-(2-hydroxypropyl) carboxymethyl betaine, oleyl dimethyl gamma-carboxypropyl betaine, and lauryl bis-(2-hydroxypropyl)alpha-carboxyethyl betaine. The sulfobetaines may be represented by coco dimethyl sulfopropyl betaine, stearyl dimethyl sulfopropyl betaine, lauryl dimethyl sulfoethyl betaine, lauryl bis-(2-hydroxyethyl) sulfopropyl betaine and the like; amidobetaines and amidosulfobetaines, wherein the RCONH(CH₂)₃ radical, wherein R is a C₁₁-C₁₇ alkyl, is attached to the nitrogen atom of the betaine are also useful in this invention.

Cationic surfactants can also be utilized in the present invention, especially in fabric softener and hair conditioner products. When used in making products that contain cationic surfactants as the major surfactants, it is preferred that such cationic surfactants are present in an amount ranging from about 2% to about 30%, preferably from about 3% to about 20%, more preferably from about 5% to about 15% by total weight of the solid sheet article.

Cationic surfactants may include DEQA compounds, which encompass a description of diamido actives as well as actives with mixed amido and ester linkages. Preferred DEQA compounds are typically made by reacting alkanolamines such as MDEA (methyldiethanolamine) and TEA (triethanolamine) with fatty acids. Some materials that typically result from such reactions include N,N-di(acyl-oxyethyl)-N,N-dimethylammonium chloride or N,N-di(acyl-oxyethyl)-N,N-methylhydroxyethylammonium methylsulfate wherein the acyl group is derived from animal fats, unsaturated, and polyunsaturated, fatty acids.

Other suitable actives for use as a cationic surfactant include reaction products of fatty acids with dialkylenetriamines in, e.g., a molecular ratio of about 2:1, said reaction products containing compounds of the formula:

R¹—C(O)—NH—R²—NH—R³—NH—C(O)—R¹
wherein R¹, R² are defined as above, and each R³ is a C₁₋₆ alkylene group, preferably an ethylene group. Examples of these actives are reaction products of tallow acid, canola acid, or oleic acids with diethylenetriamine in a molecular ratio of about 2:1, said reaction product mixture containing N,N″-ditallowoyldiethylenetriamine, N,N″-dicanola-oyldiethylenetriamine, or N,N″-dioleoyldiethylenetriamine, respectively, with the formula:

R¹—C(O)—NH—CH₂CH₂—NH—CH₂CH₂—NH—C(O)—R¹
wherein R² and R³ are divalent ethylene groups, R¹ is defined above and an acceptable examples of this structure when R¹ is the oleoyl group of a commercially available oleic acid derived from a vegetable or animal source, include EMERSOL® 223LL or EMERSOL® 7021, available from Henkel Corporation.

Another active for use as a cationic surfactant has the formula:

[R¹—C(O)—NR—R²—N(R)₂—R³—NR—C(O)—R¹]⁺X⁻
wherein R, R¹, R², R³ and X⁻ are defined as above. Examples of this active are the di-fatty amidoamines based softener having the formula:

[R¹—C(O)—NH—CH₂CH₂—N(CH₃)(CH₂CH₂OH)—CH₂CH₂—NH—C(O)—R¹]⁺CH₃SO₄⁻
wherein R¹—C(O) is an oleoyl group, soft tallow group, or a hardened tallow group available commercially from Degussa under the trade names VARISOFT® 222LT, VARISOFT® 222, and VARISOFT® 110, respectively.

A second type of DEQA (“DEQA (2)”) compound suitable as a active for use as a cationic surfactant has the general formula:

[R₃N⁺CH₂CH(YR¹)(CH₂YR¹)]X⁻
wherein each Y, R, R¹, and X⁻ have the same meanings as before. An example of a preferred DEQA (2) is the “propyl” ester quaternary ammonium fabric softener active having the formula 1,2-di(acyloxy)-3-trimethylammoniopropane chloride.

Suitable polymeric surfactants for use in the personal care compositions of the present invention include, but are not limited to, block copolymers of ethylene oxide and fatty alkyl residues, block copolymers of ethylene oxide and propylene oxide, hydrophobically modified polyacrylates, hydrophobically modified celluloses, silicone polyethers, silicone copolyol esters, diquaternary polydimethylsiloxanes, and co-modified amino/polyether silicones.

### 3. Plasticizers

In a preferred embodiment of the present invention, the flexible, porous, dissolvable solid sheet article of the present invention further comprises a plasticizer, preferably in the amount ranging from about 0.1% to about 25%, preferably from about 0.5% to about 20%, more preferably from about 1% to about 15%, most preferably from 2% to 12%, by total weight of said solid sheet article. Correspondingly, the wet pre-mixture used for forming such solid sheet article may comprise from about 0.02% to about 20% by weight of said wet pre-mixture, in one embodiment from about 0.1% to about 10% by weight of said wet pre-mixture, in one embodiment from about 0.5% to about 5% by weight of the wet pre-mixture.

Suitable plasticizers for use in the present invention include, for example, polyols, copolyols, polycarboxylic acids, polyesters, dimethicone copolyols, and the like.

Examples of useful polyols include, but are not limited to: glycerin, diglycerin, ethylene glycol, polyethylene glycol (especially 200-600), propylene glycol, butylene glycol, pentylene glycol, glycerol derivatives (such as propoxylated glycerol), glycidol, cyclohexane dimethanol, hexanediol, 2,2,4-trimethylpentane-1,3-diol, pentaerythritol, urea, sugar alcohols (such as sorbitol, mannitol, lactitol, xylitol, maltitol, and other mono- and polyhydric alcohols), mono-, di- and oligo-saccharides (such as fructose, glucose, sucrose, maltose, lactose, high fructose corn syrup solids, and dextrins), ascorbic acid, sorbates, ethylene bisformamide, amino acids, and the like.

Examples of polycarboxylic acids include, but are not limited to citric acid, maleic acid, succinic acid, polyacrylic acid, and polymaleic acid.

Examples of suitable polyesters include, but are not limited to, glycerol triacetate, acetylated-monoglyceride, diethyl phthalate, triethyl citrate, tributyl citrate, acetyl triethyl citrate, acetyl tributyl citrate.

Examples of suitable dimethicone copolyols include, but are not limited to, PEG-12 dimethicone, PEG/PPG-18/18 dimethicone, and PPG-12 dimethicone.

Other suitable platicizers include, but are not limited to, alkyl and allyl phthalates; napthalates; lactates (e.g., sodium, ammonium and potassium salts); sorbeth-30; urea; lactic acid; sodium pyrrolidone carboxylic acid (PCA); sodium hyraluronate or hyaluronic acid; soluble collagen; modified protein; monosodium L-glutamate; alpha & beta hydroxyl acids such as glycolic acid, lactic acid, citric acid, maleic acid and salicylic acid; glyceryl polymethacrylate; polymeric plasticizers such as polyquaterniums; proteins and amino acids such as glutamic acid, aspartic acid, and lysine; hydrogen starch hydrolysates; other low molecular weight esters (e.g., esters of C₂-C₁₀ alcohols and acids); and any other water soluble plasticizer known to one skilled in the art of the foods and plastics industries; and mixtures thereof.

Particularly preferred examples of plasticizers include glycerin, ethylene glycol, polyethylene glycol, propylene glycol, and mixtures thereof. Most preferred plasticizer is glycerin.

### 4. Additional Ingredients

In addition to the above-described ingredients, e.g., the water-soluble polymer, the surfactant(s) and the plasticizer, the solid sheet article of the present invention may comprise one or more additional ingredients, depending on its intended application. Such one or more additional ingredients may be selected from the group consisting of fabric care actives, dishwashing actives, hard surface cleaning actives, beauty and/or skin care actives, personal cleansing actives, hair care actives, oral care actives, feminine care actives, baby care actives, and any combinations thereof.

Suitable fabric care actives include but are not limited to: organic solvents (linear or branched lower C₁-C₈ alcohols, diols, glycerols or glycols; lower amine solvents such as C₁-C₄ alkanolamines, and mixtures thereof; more specifically 1,2-propanediol, ethanol, glycerol, monoethanolamine and triethanolamine), carriers, hydrotropes, builders, chelants, dispersants, enzymes and enzyme stabilizers, catalytic materials, bleaches (including photobleaches) and bleach activators, perfumes (including encapsulated perfumes or perfume microcapsules), colorants (such as pigments and dyes, including hueing dyes), brighteners, dye transfer inhibiting agents, clay soil removal/anti-redeposition agents, structurants, rheology modifiers, suds suppressors, processing aids, fabric softeners, anti-microbial agents, and the like.

Suitable hair care actives include but are not limited to: moisture control materials of class II for frizz reduction (salicylic acids and derivatives, organic alcohols, and esters), cationic surfactants (especially the water-insoluble type having a solubility in water at 25° C. of preferably below 0.5 g/100 g of water, more preferably below 0.3 g/100 g of water), high melting point fatty compounds (e.g., fatty alcohols, fatty acids, and mixtures thereof with a melting point of 25° C. or higher, preferably 40° C. or higher, more preferably 45° C. or higher, still more preferably 50° C. or higher), silicone compounds, conditioning agents (such as hydrolyzed collagen with tradename Peptein 2000 available from Hormel, vitamin E with tradename Emix-d available from Eisai, panthenol available from Roche, panthenyl ethyl ether available from Roche, hydrolyzed keratin, proteins, plant extracts, and nutrients), preservatives (such as benzyl alcohol, methyl paraben, propyl paraben and imidazolidinyl urea), pH adjusting agents (such as citric acid, sodium citrate, succinic acid, phosphoric acid, sodium hydroxide, sodium carbonate), salts (such as potassium acetate and sodium chloride), coloring agents, perfumes or fragrances, sequestering agents (such as disodium ethylenediamine tetra-acetate), ultraviolet and infrared screening and absorbing agents (such as octyl salicylate), hair bleaching agents, hair perming agents, hair fixatives, anti-dandruff agents, anti-microbial agents, hair growth or restorer agents, co-solvents or other additional solvents, and the like.

Suitable beauty and/or skin care actives include those materials approved for use in cosmetics and that are described in reference books such as the CTFA Cosmetic Ingredient Handbook, Second Edition, The Cosmetic, Toiletries, and Fragrance Association, Inc. 1988, 1992. Further non-limiting examples of suitable beauty and/or skin care actives include preservatives, perfumes or fragrances, coloring agents or dyes, thickeners, moisturizers, emollients, pharmaceutical actives, vitamins or nutrients, sunscreens, deodorants, sensates, plant extracts, nutrients, astringents, cosmetic particles, absorbent particles, fibers, anti-inflammatory agents, skin lightening agents, skin tone agent (which functions to improve the overall skin tone, and may include vitamin B3 compounds, sugar amines, hexamidine compounds, salicylic acid, 1,3-dihydroxy-4-alkybenzene such as hexylresorcinol and retinoids), skin tanning agents, exfoliating agents, humectants, enzymes, antioxidants, free radical scavengers, anti-wrinkle actives, anti-acne agents, acids, bases, minerals, suspending agents, pH modifiers, pigment particles, anti-microbial agents, insect repellents, shaving lotion agents, co-solvents or other additional solvents, and the like.

The solid sheet article of the present invention may further comprise other optional ingredients that are known for use or otherwise useful in compositions, provided that such optional materials are compatible with the selected essential materials described herein, or do not otherwise unduly impair product performance.

Non-limiting examples of product type embodiments that can be formed by the solid sheet article of the present invention include laundry detergent products, fabric softening products, hand cleansing products, hair shampoo or other hair treatment products, body cleansing products, shaving preparation products, dish cleaning products, personal care substrates containing pharmaceutical or other skin care actives, moisturizing products, sunscreen products, beauty or skin care products, deodorizing products, oral care products, feminine cleansing products, baby care products, fragrance-containing products, and so forth.

### Test 1: Scanning Electron Microscopic (SEM) Method for Determining Surface Average Pore Diameter of the Sheet Article

A Hitachi TM3000 Tabletop Microscope (S/N: 123104-04) is used to acquire SEM micrographs of samples. Samples of the solid sheet articles of the present invention are approximately 1 cm×1 cm in area and cut from larger sheets. Images are collected at a magnification of 50×, and the unit is operated at 15 kV. A minimum of 5 micrograph images are collected from randomly chosen locations across each sample, resulting in a total analyzed area of approximately 43.0 mm² across which the average pore diameter is estimated.

The SEM micrographs are then firstly processed using the image analysis toolbox in Matlab. Where required, the images are converted to grayscale. For a given image, a histogram of the intensity values of every single pixel is generated using the ‘imhist’ Matlab function. Typically, from such a histogram, two separate distributions are obvious, corresponding to pixels of the brighter sheet surface and pixels of the darker regions within the pores. A threshold value is chosen, corresponding to an intensity value between the peak value of these two distributions. All pixels having an intensity value lower than this threshold value are then set to an intensity value of 0, while pixels having an intensity value higher are set to 1, thus producing a binary black and white image. The binary image is then analyzed using ImageJ (https://imagej.nih.gov, version 1.52a), to examine both the pore area fraction and pore size distribution. The scale bar of each image is used to provide a pixel/mm scaling factor. For the analysis, the automatic thresholding and the analyze particles functions are used to isolate each pore. Output from the analyze function includes the area fraction for the overall image and the pore area and pore perimeter for each individual pore detected.

Average Pore Diameter is defined as D_{A}50: 50% of the total pore area is comprised of pores having equal or smaller hydraulic diameters than the D_{A}50 average diameter.

$$Hydraulic diameter = ‘ 4 * Pore area ( {m}^{2} ) / Pore perimeter ( m ) ’ .$$

It is an equivalent diameter calculated to account for the pores not all being circular.

### Test 2: Micro-Computed Tomographic (CT) Method for Determining Overall or Regional Average Pore Size and Average Cell Wall Thickness of the Open Cell Foams (OCF)

Porosity is the ratio between void-space to the total space occupied by the OCF. Porosity can be calculated from μCT scans by segmenting the void space via thresholding and determining the ratio of void voxels to total voxels. Similarly, solid volume fraction (SVF) is the ratio between solid-space to the total space, and SVF can be calculated as the ratio of occupied voxels to total voxels. Both Porosity and SVF are average scalar-values that do not provide structural information, such as, pore size distribution in the height-direction of the OCF, or the average cell wall thickness of OCF struts.

To characterize the 3D structure of the OCFs, samples are imaged using a μCT scanning instrument capable of acquiring a dataset at high isotropic spatial resolution. Here is GE phoenix vltomeix m with the follow settings: 240 kv micro focus tube, 180 kilo-volt and 120 micro-ampere, 500 projections images; 500 micro-second and 5 averages, a voxel size less than 10 micrometer per pixel. After scanning, the projection images are reconstructed into the 3D image and converted to 8-bit format stack of two dimensional images in the height-direction (or Z-direction) for analysis.

The stack of those images was used to estimate the change in sphere diameter from slice to slice as a function of OCF depth. It is, firstly, differentiate the wall and pore via threshold, and then run the “Local Thickness” script in ImageJ (see Robert Dougherty and Karl-Heinz Kunzelmann, Microscopy & Microanalysis, August 2007, 13(S02)) to obtain the pore diameter.

To obtain a sample for measurement, lay a single layer out flat and cut a piece. During sampling, folds, wrinkles, and tears are avoided. Likewise, possibility of distortion and compression are minimized. A ring holder is used to support the cut sample so that direct pressure to its upper and bottom surfaces can be avoided.

The “Local Thickness” script gives a calculate result of sphere diameter from slice to slice. For Overall Average Pore Diameter (μm), it is the average of all the diameter number. For Top Average Pore Diameter (μm), Middle Average Pore Diameter (μm) and Bottom Average Pore Diameter (μm), the image stack is divided into three equal portions from top to bottom, and then calculate the average of each part.

### Test 3: Percent Open Cell Content of the Sheet Article

The Percent Open Cell Content is measured via gas pycnometry. Gas pycnometry is a common analytical technique that uses a gas displacement method to measure volume accurately. Inert gases, such as helium or nitrogen, are used as the displacement medium. A sample of the solid sheet article of the present invention is sealed in the instrument compartment of known volume, the appropriate inert gas is admitted, and then expanded into another precision internal volume. The pressure before and after expansion is measured and used to compute the sample article volume.

ASTM Standard Test Method D2856 provides a procedure for determining the percentage of open cells using an older model of an air comparison pycnometer. This device is no longer manufactured. However, one can determine the percentage of open cells conveniently and with precision by performing a test which uses Micromeritics' AccuPyc Pycnometer. The ASTM procedure D2856 describes 5 methods (A, B, C, D, and E) for determining the percent of open cells of foam materials. For these experiments, the samples can be analyzed using an Accupyc 1340 using nitrogen gas with the ASTM foampyc software. Method C of the ASTM procedure is to be used to calculate to percent open cells. This method simply compares the geometric volume as determined using calipers and standard volume calculations to the open cell volume as measured by the Accupyc, according to the following equation:

$$Open cell percentage = Open cell volume of sample / Geometric volume of sample * 100$$

It is recommended that these measurements be conducted by Micromeretics Analytical Services, Inc. (One Micromeritics Dr, Suite 200, Norcross, GA 30093). More information on this technique is available on the Micromeretics Analytical Services web sites (www.particletesting.com or www.micromeritics.com), or published in “Analytical Methods in Fine particle Technology” by Clyde Orr and Paul Webb.

### Test 4: Final Moisture Content of the Sheet Article

Final moisture content of the solid sheet article of the present invention is obtained by using a Mettler Toledo HX204 Moisture Analyzer (S/N B706673091). A minimum of 1 g of the dried sheet article is placed on the measuring tray. The standard program is then executed, with additional program settings of 10 minutes analysis time and a temperature of 110° C.

### Test 5: Thickness of the Sheet Article

Thickness of the flexible, porous, dissolvable solid sheet article of the present invention is obtained by using a micrometer or thickness gage, such as the Mitutoyo Corporation Digital Disk Stand Micrometer Model Number IDS-1012E (Mitutoyo Corporation, 965 Corporate Blvd, Aurora, IL, USA 60504). The micrometer has a 1-inch diameter platen weighing about 32 grams, which measures thickness at an application pressure of about 0.09 psi (6.32 gm/cm²).

The thickness of the flexible, porous, dissolvable solid sheet article is measured by raising the platen, placing a section of the sheet article on the stand beneath the platen, carefully lowering the platen to contact the sheet article, releasing the platen, and measuring the thickness of the sheet article in millimeters on the digital readout. The sheet article should be fully extended to all edges of the platen to make sure thickness is measured at the lowest possible surface pressure, except for the case of more rigid substrates which are not flat.

### Test 6: Basis Weight of the Sheet Article

Basis Weight of the flexible, porous, dissolvable solid sheet article of the present invention is calculated as the weight of the sheet article per area thereof (grams/m²). The area is calculated as the projected area onto a flat surface perpendicular to the outer edges of the sheet article. The solid sheet articles of the present invention are cut into sample squares of 10 cm×10 cm, so the area is known. Each of such sample squares is then weighed, and the resulting weight is then divided by the known area of 100 cm² to determine the corresponding basis weight.

For an article of an irregular shape, if it is a flat object, the area is thus computed based on the area enclosed within the outer perimeter of such object. For a spherical object, the area is thus computed based on the average diameter as 3.14×(diameter/2)². For a cylindrical object, the area is thus computed based on the average diameter and average length as diameter x length. For an irregularly shaped three-dimensional object, the area is computed based on the side with the largest outer dimensions projected onto a flat surface oriented perpendicularly to this side. This can be accomplished by carefully tracing the outer dimensions of the object onto a piece of graph paper with a pencil and then computing the area by approximate counting of the squares and multiplying by the known area of the squares or by taking a picture of the traced area (shaded-in for contrast) including a scale and using image analysis techniques.

### Test 7: Density of the Sheet Article

Density of the flexible, porous, dissolvable solid sheet article of the present invention is determined by the equation: Calculated Density=Basis Weight of porous solid/(Porous Solid Thickness×1,000). The Basis Weight and Thickness of the dissolvable porous solid are determined in accordance with the methodologies described hereinabove.

### Test 8: Specific Surface Area of the Sheet Article

The Specific Surface Area of the flexible, porous, dissolvable solid sheet article is measured via a gas adsorption technique. Surface Area is a measure of the exposed surface of a solid sample on the molecular scale. The BET (Brunauer, Emmet, and Teller) theory is the most popular model used to determine the surface area and is based upon gas adsorption isotherms. Gas Adsorption uses physical adsorption and capillary condensation to measure a gas adsorption isotherm. The technique is summarized by the following steps; a sample is placed in a sample tube and is heated under vacuum or flowing gas to remove contamination on the surface of the sample. The sample weight is obtained by subtracting the empty sample tube weight from the combined weight of the degassed sample and the sample tube. The sample tube is then placed on the analysis port and the analysis is started. The first step in the analysis process is to evacuate the sample tube, followed by a measurement of the free space volume in the sample tube using helium gas at liquid nitrogen temperatures. The sample is then evacuated a second time to remove the helium gas. The instrument then begins collecting the adsorption isotherm by dosing krypton gas at user specified intervals until the requested pressure measurements are achieved. Samples may then analyzed using an ASAP 2420 with krypton gas adsorption. It is recommended that these measurements be conducted by Micromeretics Analytical Services, Inc. (One Micromeritics Dr, Suite 200, Norcross, GA 30093). More information on this technique is available on the Micromeretics Analytical Services web sites (www.particletesting.com or www.micromeritics.com), or published in a book, “Analytical Methods in Fine Particle Technology”, by Clyde Orr and Paul Webb.

### Test 9: Dissolution Rate

Firstly, the solid sheets are stored under ambient relative humidity of 50±2% and ambient temperature of 23±1° C. for 24 hours (i.e., a conditioning step). Following the initial conditioning step described above, 25 mm diameter discs are firstly cut from the large solid sheet using a 25 mm hollow hole punch. The required number of foam discs is set such that the total mass of all foam discs is no less than 0.1 g.

The required number of foam discs are then stacked in a head to toe orientation and placed inside an Omnifit™ EZ chromatography column (006EZ-25-10-AF) having 25 mm inner diameter, 100m length and an adjustable, removable endpiece. The stack of foam discs is placed inside the column such that the direction of flow through the column is perpendicular to the top surface of the foam discs. Once placed inside the column, the endpiece is inserted into the column and adjusted until the perpendicular distance between the two inner frits is equal to the thickness of the stack of foam discs.

Masterflex silicone tubing (MFLEX SILICONE #25 25′) and a Masterflex peristaltic pump (MFLX L/S 1CH 300R 115/230 13124) are used to control the flow of water through the column. The system flow rate is calibrated by flowing water through the pump, tubing and an empty column at different pump RPM settings and recording the volume of water collected over a defined period of time. For all experiments a flow rate of 5 litres per hour was utilized.

The inlet and outlet tubing are both placed inside a 1 litre beaker containing 500 ml of deionised water at ambient temperature. The beaker is placed on a magnetic stirrer plate, and a magnetic stirrer bar having length 23 mm and thickness 10 mm is placed in the beaker, and the stirrer rotation speed is set to 300 rpm. A Mettler Toledo S230 conductivity meter is calibrated to 1413 μS/cm and the probe placed in the beaker of water.

The flow of water through the system is started. Once the first drops of water can be visibly seen inside the column and in contact with the foam, the data recording function of the conductivity meter is started. Data is recorded for at least 20 minutes.

In order to estimate the time required to reach a 90 or 95% percentage dissolution of the foam, a calibration curve is firstly generated where layers of the foam discs are dropped one a time into a stirred beaker of 500 ml deionised water. The mass of each individual foam disc, and the conductivity after 5 minutes are both recorded. This process is repeated for up to 5 discs total. A linear function is fitted to the data, which is then used to estimate the maximum conductivity in each dissolution experiment based on the total mass of the foam discs placed in the column. The percentage dissolution is then calculated as

$$\% Dissolution = Experimentally measured conductivity / Maximum conductivity * 100$$

The time required to achieve 90 or 95 percentage dissolution is then found from this calculated data. The calibration procedure is repeated for each formula tested.

### Test 10: Bubble Size

The bubble size of aerated pre-mixture is measured as follows:

Rectangular glass cover slides, having a width and a length of 2 cm and a thickness of 1 mm are firstly glued onto a glass slide having a width of 6 cm and a length of 2 cm, such that a cavity having a thickness of 1 mm, a length of 2 cm and a width of slightly less than 2 cm is located in the center of the glass slide. The width of the cavity must be kept at less than 2 cm so that an additional cover slide can be placed on top of the cavity.

To capture the image for bubble size analysis, the aerated liquid foam is deposited into the cavity using a spatula and another cover slide placed on top and pressed down gently, in order to reduce the thickness of the liquid to 1 mm.

A SMZ-T4 Chongqing Optec microscope and RZIMAGE MicroUL300 digital camera were used to capture the images. The glass slide was placed onto the backlit area of the microscope, and the magnification adjusted such that the image area was no less than 16 mm². An additional image was taken with a transparent ruler placed in the image area, such that the graduated lines could be seen and used to determine the pixel to distance ratio.

The bubble sizes were calculated using the ‘imfindcircles’ function in the Image Analysis Toolbox of the Matlab 2017b software. For each image, the function was called four times, for pixel size ranges of 21 to 40, 41 to 50, 51 to 100 and 101 to 200, respectively, where 20 pixels corresponds to an approximate length of 60 micron. The sensitivity parameter was set to 0.95. The bubble radii estimated from each call of the function were combined to generate a single distribution, and the radii converted to microns using the calibration image generated with the transparent ruler.

### EXAMPLES

The following examples further describe and demonstrate embodiments within the scope of the present invention. The examples are given solely for the purpose of illustration and are not to be construed as limitations of the present invention, as many variations thereof are possible without departing from the spirit and scope of the invention. All exemplified amounts are concentrations by weight of the total composition, i.e., wt/wt percentages, unless otherwise specified.

### Example 1: Improved Pore Structure of the Solid Sheet Article in a Step-Wise Belt Drying Process

A wet pre-mixture (i.e., a slurry) containing the ingredients of the solid sheet article (Formulation 1) shown in the following Table 1 and additional water was prepared, to result in a total solids content of about 32% by weight (i.e., the total water content in the slurry is about 68% by weight).

TABLE 1

| | (Wet) | (Dry) |
|---|---|---|
| Materials: | w/w % | w/w % |
| Polyvinyl alcohol (High Molecular Weight)¹ | 6.8% | 20.0% |
| Polyvinyl alcohol (Low Molecular Weight)² | 3.4% | 10.0% |
| Glycerin | 4.1% | 12.0% |
| Sodium Laureth 1 Sulfate | 12.3% | 36.0% |
| Sodium Laureth 3 Sulfate | 0.7% | 2.2% |
| Amine Oxide | 3.6% | 10.5% |
| Soap powder | 0.7% | 2.0% |
| Perfume Microcapsule | 0.4% | 1.3% |
| Water | 68.0% | 6.0% |

¹Molecular weight 85,000, Degree of Hydrolysis 87%
²Molecular weight 25,000, Degree of Hydrolysis 87%

The slurry so formed was then aerated and dried either in a rotary drum drier or in a belt drier by using parameters as shown below. Particularly, the belt drier used herein is shown in FIG. 1 and comprises three heating zones in which the temperatures in these heating zones are shown in Table 3 below.

TABLE 2

| Process | Drying method/Temperature | Parameters |
|---|---|---|
| Process 1 | Drum drier | Slurry Temperature before and during |
| (Comparative) | Bottom 85° C. | aeration: 60-70° C. |
| Process 2 | Belt drier (Fixed heating) | Mixing head speed setting for aerator: 300 |
| (Comparative) | Bottom 140° C. | Air flow rate setting for aerator: 100 |
| Process 3 | Belt drier (Fixed heating) | For drum drier only: |
| (Comparative) | Bottom 80° C./Top 140° C. | Rotary drum drier rotational speed: 0.120 |
| Process 4 | Belt drier (Fixed heating) | rpm |
| (Comparative) | Bottom 140° C./Top 80° C. | Speed of spinning bar on drum drier: 150 rpm |
| Process 5 | Belt drier (Step-wise heating) | Distance between spinning bar and drum |
| (Comparative) | Bottom 100-140° C./Top 140- | drier: 2 mm |
| | 100° C. | For belt drier only: |
| Process 6 | Belt drier (Step-wise heating) | Drying linear speed: 0.5 to 1.0 m/min |
| (Inventive) | Bottom 120-80° C./Top 100- | Heating zone area: ~3.4 m × ~0.4 m (length × |
| | 140° C. | width) |
| Process 7 | Belt drier (Step-wise heating) | |
| (Inventive) | Bottom 180-130° C./Top 100- | |
| | 160° C. | |

TABLE 3

| | Bottom | | Bottom | | Bottom | | Top | | Top | | Top | |
|---|---|---|---|---|---|---|---|---|---|---|---|---|
| Process | Zone 1 | | Zone 2 | | Zone 3 | | Zone 1 | | Zone 2 | | Zone 3 | |
| 1 | 85° C. | | | | | | N/A | | | | | |
| 2 | 140° | C. | 140° | C. | 140° | C. | N/A | | | | | |
| 3 | 80° | C. | 80° | C. | 80° | C. | 140° | C. | 140° | C. | 140° | C. |
| 4 | 140° | C. | 140° | C. | 140° | C. | 80° | C. | 80° | C. | 80° | C. |
| 5 | 100° | C. | 120° | C. | 140° | C. | 140° | C. | 120° | C. | 100° | C. |
| 6 | 120° | C. | 120° | C. | 80° | C. | 100° | C. | 120° | C. | 140° | C. |
| 7 | 180° | C. | 155° | C. | 130° | C. | 100° | C. | 130° | C. | 160° | C. |

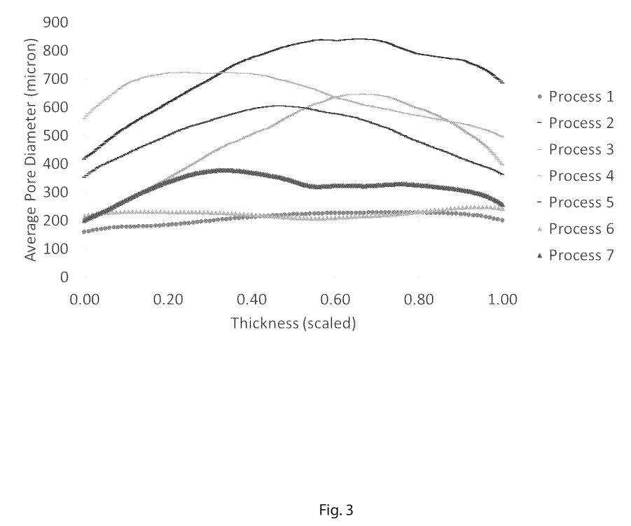

According to Tests 2, 5 and 6 as described herein, parameters of solid sheet article prepared by Processes 1 to 7 including Overall Average Pore Diameter (OAPD), Standard Deviation of OAPD, Bottom/Middle/Top Average Pore Diameters, Thickness, Basis Weight were measured and shown in Table 4 below. Further, average pore diameters at different heights (i.e., at different thickness) across the whole solid sheet article prepared by Processes 1 to 7 are shown in FIG. 3.

TABLE 4

| | Overall | Standard | Bottom | Middle | Top | | |
|---|---|---|---|---|---|---|---|
| | Average | Deviation | Average | Average | Average | | |
| | Pore | of | Pore | Pore | Pore | | Basis |
| | Diameter | OAPD | Diameter | Diameter | Diameter | Thickness | weight |
| Process | (μm) | (μm) | (μm) | (μm) | (μm) | (mm) | (g/m²) |
| 1 | 208 | 76 | 182.2 | 219.0 | 222.6 | 1.0 | 160 |
| 2 | 722 | 457 | 579.1 | 804.9 | 781.3 | 2.2 | 73 |
| 3 | 640 | 338 | 685.8 | 679.0 | 559.4 | 2.1 | 74 |
| 4 | 484 | 285 | 321.5 | 564.0 | 562.4 | 2.3 | 80 |
| 5 | 505 | 318 | 471.1 | 586.2 | 460.4 | 1.9 | 80 |
| 6 | 226 | 104 | 229.2 | 214.7 | 234.7 | 1.9 | 90 |
| 7 | 321 | 140 | 306.1 | 344.6 | 312.2 | 1.8 | 77 |

The data (see FIG. 3 and Table 4) shows that the step-wise belt drying process according to the present disclosure (i.e., Processes 6 and 7 in which wherein T_{b1}>Tₜ₁; T_{b1}>T_{b2}; and Tₜ₁<Tₜ₂) can achieve a significantly improved uniformity in the distribution of pore size in the solid sheet compared to common belt heating processes (e.g., Processes 2 to 5). Particularly, the curves for Processes 6 and 7 in FIG. 3 (shown as triangle) are flat, being similar with Process 1 (shown as circle) while the curves for Processes 2 to 5 (shown as dash) have a clear peak, indicating the pore sizes in the articles prepared by Processes 6 and 7 are distributed more uniformly compared to that in the articles prepared by Processes 2 to 5. At the same time, the step-wise belt drying process according to the present disclosure (i.e., Processes 6 and 7) can make a much thicker solid sheet compared to the drum drying process (i.e., 1.9 or 1.8 mm vs. 1.0 mm). Also as shown in Table 4, the Standard Deviation of Overall Average Pore Diameter in the solid sheet obtained by the step-wise belt heating process (Processes 6 and 7) is very close to that obtained by the drum drier (Process 1), i.e., 104 μm/140 μm vs. 76 μm.

Further, as an additional benefit, the Overall Average Pore Diameter in the solid sheet obtained by the step-wise belt drying process according to the present disclosure is within a preferred range which may provide a balance between the dissolution and the leakage of juice/paste contained in the multilayered sheet article.

### Example 2: Compositions of the Article for a Step-Wise Belt Drying Process

The following are examples of Articles prepared by the step-wise drying process according to the present disclosure as described in Example 1.

TABLE 5

| | Sheet a | Sheet b | Sheet c | Sheet d | Sheet e |
|---|---|---|---|---|---|
| Materials (Dry) w/w % | Laundry | | | PCC/Hair | |
| Polyvinyl alcohol (with a degree | 0.00 | 0.00 | 12.00 | 0.00 | 0.00 |
| of polymerization | | | | | |
| of about 2400) | | | | | |
| Polyvinyl alcohol (with a degree | 18.00 | 18.00 | 0.00 | 23.72 | 24.00 |
| of polymerization | | | | | |
| of about 1700) | | | | | |
| Polyvinyl alcohol (with a degree | 6.00 | 0.00 | 0.00 | 0.00 | 0.00 |
| of polymerization | | | | | |
| of about 500) | | | | | |
| Glycerin | 3.51 | 9.00 | 9.00 | 9.04 | 9.15 |
| Linear Alkylbenzene Sulfonate | 40.00 | 56.00 | 56.00 | 0.00 | 0.00 |
| Sodium Lauryl Sulfate | 0.00 | 0.00 | 6.00 | 36.53 | 36.97 |
| C12-C14 Ethoxylated alcohol | 16.00 | 0.00 | 0.00 | 0.00 | 0.00 |
| Sodium Laureth-3 Sulfate | 4.60 | 6.00 | 6.00 | 9.91 | 10.03 |
| Sodium Lauroamphoacetate | 0.00 | 0.00 | 0.00 | 11.16 | 11.30 |
| Ethoxylated Polyethyleneimine | 1.50 | 2.00 | 2.00 | 0.00 | 0.00 |
| Palm kernel fatty acid soap | 2.07 | 2.00 | 2.00 | 0.00 | 0.00 |
| powder | | | | | |
| Sodium Aluminosilicate | 0.95 | 0.00 | 0.00 | 0.00 | 0.00 |
| (crystalline)/Zeolite | | | | | |
| Denatonium Benzoate | 0.04 | 0.00 | 0.00 | 0.00 | 0.01 |
| Sodium Benzoate | 0.00 | 0.00 | 0.00 | 0.45 | 0.45 |
| Citric Acid | 0.00 | 0.00 | 0.00 | 2.07 | 2.09 |
| Perfume | 0.00 | 0.00 | 0.00 | 1.12 | 0.00 |
| Water | 6.00 | 6.00 | 6.00 | 6.00 | 6.00 |
| Miscellaneous | 1.33 | 1.00 | 1.00 | 0.00 | 0.00 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A continuous process for preparing a sheet article, comprising the steps of:
a) preparing a wet pre-mixture comprising a water-soluble polymer and a surfactant and having a viscosity of from 1,000 cps to 25,000 cps measured at 40° C. and 1 s⁻¹;
b) aerating said wet pre-mixture to form an aerated wet pre-mixture having a density of from 0.05 to 0.5 g/ml;
c) forming said aerated wet pre-mixture into a sheet having a top side and a bottom side; and
d) drying said formed sheet of aerated wet pre-mixture on a conveying belt with the bottom side of said formed sheet contacting said conveying belt,
wherein the conveying belt is configured to sequentially pass through multiple heating zones with heating temperatures ranging from 70° C. to 200° C.; wherein said multiple heating zones comprises a first heating zone and a second heating zone which is located downstream of said first heating zone;
wherein said first heating zone is configured to simultaneously heat the top and bottom sides of said formed sheet at a first top heating temperature (Tₜ₁) and a first bottom heating temperature (T_{b1}) for a first heating duration of from 0.01 minutes to 20 minutes; wherein said second heating zone is configured to simultaneously heat the top and bottom sides of said formed sheet at a second top heating temperature (Tₜ₂) and a second bottom heating temperature (T_{b2}) for a second heating duration of from 0.01 minutes to 20 minutes; and
wherein T_{b1}>Tₜ₁; T_{b1}>T_{b2}; and Tₜ₁<Tₜ₂.

2. The process of claim 1, wherein the first top heating temperature (Tₜ₁) ranges from 70° C. to 160° C.; wherein the first bottom heating temperature (T_{b1}) ranges from 80° C. to 190° C.; wherein the second top heating temperature (Tₜ₂) ranges from 100° C. to 200° C.; and wherein the second bottom heating temperature (T_{b2}) ranges from 70° C. to 170° C.

3. The process of claim 1, wherein Tₜ₁ ranges from 80° C. to 150° C.; wherein T_{b1} ranges from 90° C. to 170° C.; wherein Tₜ₂ ranges from 110° C. to 190° C.; and wherein T_{b2} ranges from 70° C. to 150° C.; and
wherein T_{b2}≤Tₜ₂.

4. The process of claim 1, wherein said multiple heating zones further comprises a third heating zone and wherein said conveying belt is configured to pass through said third heating zone; wherein said third heating zone is configured to simultaneously heat the top and bottom sides of said formed sheet at a third top heating temperature (Tₜ₃) and a third bottom heating temperature (T_{b3}) for a third heating duration of from 0.01 minutes to 20 minutes; and
wherein T_{b2}≥T_{b3}; Tₜ₂≤Tₜ₃; and T_{b3}≤Tₜ₃ when said third heating zone is located downstream of said second heating zone,
wherein T_{b1}≥T_{b3}≥T_{b2}; Tₜ₁≤Tₜ₃≤Tₜ₂ when said third heating zone is located downstream of said first heating zone and upstream of said second heating zone, and
wherein T_{b3}≥T_{b1}; Tₜ₃≤Tₜ₁; and T_{b3}≥Tₜ₃ when said third heating zone is located upstream of said first heating zone.

5. The process of claim 1, wherein said multiple heating zones comprises 4, 5, 6, 7, 8, 9, 10, 15, 20, 25, 30 or more heating zones in total in which the n^{th} heating zone is configured to simultaneously heat the top and bottom sides of said formed sheet at a n^{th} top heating temperature (Tₜₙ) and a n^{th} bottom heating temperature (T_{bn}), and wherein T_{bn}≥T_{b(n+1)}; and Tₜₙ≤Tₜ₍ₙ₊₁₎.

6. The process of claim 1, wherein:
said first heating duration is from 0.05 minutes to 10 minutes;
said second heating duration is from 0.05 minutes to 10 minutes;
said third heating duration is from 0.05 minutes to 10 minutes;
the total heating duration in said multiple heating zones is from 0.05 minutes to 30 minutes;
or combinations thereof.

7. The process of claim 1, wherein said formed sheet of aerated wet pre-mixture is characterized by a thickness ranging from 0.5 mm to 20 mm.

8. The process of claim 1, wherein:
said wet pre-mixture comprises from 3% to 70% of said water-soluble polymer by total weight of said wet pre-mixture;
said wet pre-mixture comprises from 1% to 40% of said surfactant by total weight of said wet pre-mixture;
the density of the aerated wet pre-mixture is from 0.08 to 0.4 g/ml;
the wet pre-mixture is characterized by a solid content ranging from 15% to 70% by weight of said wet pre-mixture;
the wet pre-mixture is characterized by a viscosity ranging from 3,000 cps to 24,000 cps as measured at 40° C. and 1 s⁻¹;
or combinations thereof.

9. The process of claim 1, wherein said multiple heating zones are configured to heat the top sides of said formed sheet through convective heating, and to heat the bottom sides of said formed sheet through conductive heating.

10. A flexible, porous, dissolvable solid sheet article comprising a water-soluble polymer and a surfactant, wherein said solid sheet article is characterized by: (i) a thickness ranging from 1.5 mm to 20 mm; and (ii) a Percent Open Cell Content of from 80% to 99.9%; (iii) an Overall Average Pore Size of from 100 μm to 1000 μm; and (iv) a Standard Deviation of Overall Average Pore Diameter of from 10 to 250 μm;
wherein said solid sheet article has opposing top and bottom surfaces, said top surface having a Surface Average Pore Diameter that is greater than 100 μm; wherein said solid sheet article comprises a top region adjacent to said top surface, a bottom region adjacent to said bottom surface, and a middle region therebetween; wherein said top, middle, and bottom regions have the same thickness, and each of said top, middle and bottom regions is characterized by an Average Pore Size; and wherein the ratio of Average Pore Size in said bottom region over that in said top region is from 0.6 to 1.5.

11. The flexible, porous, dissolvable solid sheet article according to claim 10, wherein said solid sheet article is prepared by the process according claim 1.

12. The flexible, porous, dissolvable solid sheet article according to claim 10, wherein:
said solid sheet article is characterized by a thickness of from 1.5 mm to 20 mm;
said solid sheet article is characterized by a Percent Open Cell Content of from 85% to 99.9%;
the Overall Average Pore Size is from 20 to 600 μm;
the Standard Deviation of Overall Average Pore Diameter is from 20 to 250 μm;
or combinations thereof.

13. A system of belt drying for preparing a sheet article, wherein the system comprises:
a conveying belt which is configured to convey a wet pre-mixture and form the same into a sheet having a top side and a bottom side,
multiple heating components which are configured to dry said wet pre-mixture by heating so as to form said sheet, and
a heating source which is configured to provide heat for said multiple heating components,
wherein the conveying belt is configured to sequentially pass through said multiple heating components with heating temperatures ranging from 70° C. to 200° C.;
wherein multiple heating components comprise a first heating component and a second heating component which is located downstream of said first heating component;
wherein said first heating component is configured to simultaneously heat the top and bottom sides of said formed sheet at a first top heating temperature (Tₜ₁) and a first bottom heating temperature (T_{b1}) for a first heating duration of from 0.01 minutes to 20 minutes; wherein said second heating component is configured to simultaneously heat the top and bottom sides of said formed sheet at a second top heating temperature (Tₜ₂) and a second bottom heating temperature (T_{b2}) for a second heating duration of from 0.01 minutes to 20 minutes; and
wherein T_{b1}>Tₜ₁; T_{b1}>T_{b2}; and Tₜ₁<Tₜ₂.
